(19) United States
(12) Patent Application Publication
(10) Pub. No.: US 2008/0243933 A1
(43) Pub. Date: Oct. 2, 2008

(54) System and Method for Multi-Governance Social Networking Groups

(75) Inventors: David H. Holtzman, Herndon, VA (US); Andrew J. Nash, McLean, VA (US)

Correspondence Address: MORRISON & FOERSTER LLP, 1650 TYSONS BOULEVARD, SUITE 400, MCLEAN, VA, 22102, US

(73) Assignee: Pseuds, Inc., Herndon, VA (US)

(21) Appl. No.: 12/059,579

(22) Filed: Mar. 31, 2008

Related U.S. Application Data
(60) Provisional application No. 60/909,393, filed on Mar. 30, 2007.

(51) Int. Cl. G06F 17/30

(52) U.S. Cl. 707/104.1; 707/E17.009

(57) ABSTRACT

A system and method for providing social networking groups under distinct governance models. In one embodiment, a data store stores governance model rules. A server applies the stored rules to implement a first online social networking group under a first governance model and a second online social networking group under a second governance model.

### CROSS REFERENCE TO RELATED APPLICATION

This application claims the benefit under 35 USC 119(e) of U.S. Provisional Application No. 60/909,393, filed Mar. 30, 2007, the entirety of which is incorporated herein by reference.

### FIELD OF THE DISCLOSURE

The disclosure of the present application relates to social networking groups, and more particularly, to providing social networking groups under distinct governance models.

### BACKGROUND

The impact of transformative technology on social systems has been evident throughout the evolution of the Internet. The first generation of the Internet from 1970-1995 featured simple one-to-one or one-to-many textual communication among a professional community primarily engaged in research. The audience of individuals and participating organizations formed a community that over time engaged in broader communication and interactions. As users became more familiar with this approach, users also became comfortable with the participants with whom they communicated. This communication became more frequent and led to less formal interaction. Discussion groups formed based around common interests, text-based games, and email proliferated as a simple and elegant method for the one-to-one exchange of text messaging. Eventually this led to the need for automated list servers and the broad distribution of topical content and newsgroups through Usenet that were viewed by using text navigation (via GOPHER and WAIS, for example) that could be considered the precursor of a web browser. Each of these advances were welcomed by communities compromised predominately of government or academic professionals, concerned about their personal reputation and assuming their share of responsibility for ensuring an acceptable level of community behavior.

The second generation of Internet communication was marked by this online medium becoming a ubiquitous, global consumer utility. The period 1996 to 2006 featured an explosion of richer content, simple interactive communications, growing application functionality for e-commerce and pervasive organizational and individual adoption. The advent of the World Wide Web browser stimulated the creation of tens of millions of web sites, devoted to every imaginable subject. First generation text-based games evolved into massively multiplayer online role-playing games (MMORPGs), engaging and entertaining a vast online audience. A highly interactive medium called instant messaging augmented email as a preferred communications method. Search technology and new forms of self-expression called web logging or blogging transformed research and publishing. The rapidity of adoption and the nature of the Internet placed enormous stress on the social structure of the medium. A range of anti-social and disruptive behaviors including spam, identity theft and fraud began to erode trust within existing and newly forming communities of interest.

The technical advances during this phase of the Internet were staggering. None was more important than the introduction and build out of high speed, interoperable global networks that allowed the Internet to address a greatly expanded range of application possibilities. A graphics-intensive, high bandwidth online game was unthinkable in an environment dependent on a 56K dialup line for data transport, even if the computers at either end could have displayed the content and performed the calculations. The availability of low cost communications capacity to desktops around the globe unleashed a wave of creativity, innovation and workload distribution potential that accelerated the economic and social stresses on organizations and the ability of individuals to adapt to change.

The opportunity to exploit pervasive bandwidth accelerated the pace of change in supporting microprocessor, software, industrial design and content management technologies. The productivity, convenience and cost reduction benefits were obvious, unlocking potential for previously unimaginable innovation. Less apparent was the introduction of new vulnerabilities and risks as social norms, identity and reputation lagged. The Internet was becoming a reflection of society with the capacity for great good, but also fertile ground for criminal activity and social anarchy.

The next phase of the Internet usage has arrived, characterized by broader social participation, group interaction and user-generated content. The social media technology features forums, messaging, chat, polling and the exchange of many forms of content among individuals and groups that share a common interest, affiliation or purpose. The success of this phase will likely be dependent on the introduction and adoption of widely accepted “social norms” that are common place in our cultures but have yet to emerge in our digital interactions.

Society has relied on generations of parents and communities to develop, refine and enforce social values and standards of behavior. Internet culture is young and primitive, and the recent innovations in social networking reflect the lack of shared value systems and mechanisms for enforcing community standards. Technology has removed the distance that created natural barriers between separate cultures. The dissolving of boundaries and the reduction of cultural barriers has created uncertainty regarding values with few standards and practices that define what constitutes acceptable behavior. The governance model that best defines social media technologies to date is anarchy. The absence of constraints and structure in digital interactions can be expected to retard the adoption of these potentially transforming technologies unless a method is developed to enable traditional anthropology to be relevant and applicable in this new and rapidly evolving digital culture. Online social communities are very early in their evolution. There has been limited research in traditional scientific or academic communities regarding the impact of the absence of social norms on the forming, development, maturation or performance and vitality of online communities.

The lack of social norms in online settings is illustrated by the general inability of groups to curb or limit behaviors that they or broader society would consider to be disruptive, offensive, rude or potentially risky. The current state of the art enables bad behaviors to be “reported” and investigated, and eventually a user may be “blocked” from participation in a group. Many participants may be unaware that their personal profile data may be publicly available or shared among multiple social sites or social networks. Participants are provided with rudimentary tools, but communities and groups have limited ability to self-manage and self-govern. As with any new technology, cultural norms are required to provide an acceptable context for efficient and effective participation. To date social media has been focused primarily on direct and indirect connections of known friends, and association with new individuals through those friends. Connections rely on pre-existing trust relationships involving who you know and who others know that you know. This tight or loose affiliation is perhaps the only known system of social norms available, and is incapable of scaling to broader application by organizations or groups of any substantial size.

### SUMMARY

A system and method for providing social networking groups under distinct governance models is disclosed. In one embodiment, rules associated with governance models are stored in a database. The stored rules can be applied by a server to implement a first online social networking group under a first governance model and a second online social networking group under a second governance model.

In connection with forming an online social networking group in one embodiment, a server may provide a user with configurable options associated with a plurality of governance models. When a configuration by the user specifying one of the plurality of governance models is received, the server can implement the online social networking group based on the specified governance model.

The governance configuration can specify control of events and actions within the social networking group, such as governance via committee requiring committee approval for certain actions for example. The server can also provide members with the ability to change the governance model for the social networking group.

Governance may comprise the rules, processes, procedures, and configurations that enable leadership through a group organizer enabling single, multi, or no leader models in one embodiment. Each model may have roles and responsibilities bestowed upon a leader than can be delegated to one or many other group members, groups, or sub-groups. These rules and processes can enable or disable activities and group actions. Variants of actions, for example, can enable the procedures through which elections, voting, leadership changes, and other actions are conducted.

In various embodiments, these rules and processes can manage how group participation with regards to tools, applications, and other method interactions are conducted. The consolidation of governance, leadership, activities, action variants, and participation establish group by-laws which input data into external processes to provide group insight, such as calculating reputation, generating analytics, reporting group metrics, and monitoring group vitality for example.

### BRIEF DESCRIPTION OF THE DRAWINGS

FIG. 1 illustrates an example of a multi-governance social networking system architecture.

FIG. 2 illustrates an example of a process for forming a social networking group based on a selected governance.

FIG. 3 illustrates an example of a group architecture.

FIGS. 4A and 4B illustrate examples of relations between social networking groups.

FIGS. 5A and 5B illustrate examples of a consolidated group architecture.

FIGS. 6A and 6B illustrate examples of a federated group architecture.

FIG. 7 illustrates an example of a group sub-structure.

FIGS. 8A and 8B illustrate examples of relations between group allies and rivals.

FIG. 9 illustrates an example of a relation between groups based on interest.

FIG. 10 illustrates an example of single leader governance models that may be implemented by the system architecture.

FIG. 11 illustrates an example of multi-leader governance models that may be implemented by the system architecture.

FIG. 12 illustrates an example of no leader governance models that may be implemented by the system architecture.

FIG. 13 illustrates an example of reputation score calculation process in connection with governance of a social networking group.

FIG. 14 illustrates an example of ad serving based on group preferences provided by a leader of a social networking group.

FIG. 15 illustrates an example of ad serving based on a social networking group persona.

FIGS. 16-45 illustrate examples of a user interface associated with a multi-governance social networking system.

FIG. 46A illustrates an example of a multi-tenanted social networking system implementation.

FIG. 46B illustrates an example of a single-tenanted social networking system implementation.

FIG. 47 illustrates an example of a computing device.

### DETAILED DESCRIPTION

The present disclosure provides a multi-governance social networking system that implements social norms based on controls within the context of governance models. The system provides online groups for public and private communities with real world elements necessary for forming, managing and governing useful groups: a sense of self, a sense of stature and societal rules. In the online world, these can be translated as: identity, context, reputation and governance. This is achieved by providing a system and method for governing social network groups.

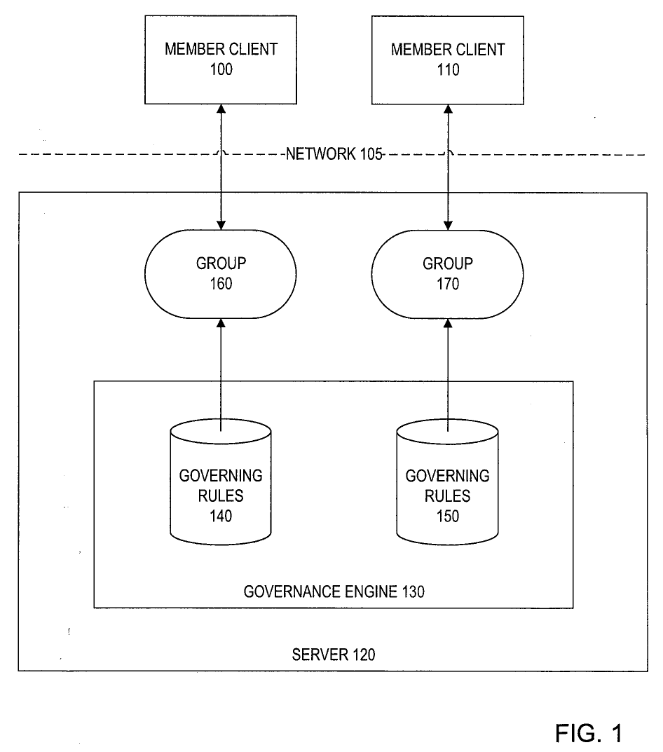

As illustrated in the embodiment of FIG. 1, a multi-governance social networking system architecture may include server 120 and governance engine 130. Server 120 enables social networking groups, such as group 160 and group 170, to be formed and implemented under distinct governance models over network 105, such as the Internet for example. Governance engine 130 can implement a particular governance model associated with a group by applying governing rules stored in a database.

In the illustrated embodiment, for example, a member of group 160 may access group 160 over network 105 using client 100. Similarly, a member of group 170 may access group 170 over network 105 using client 110. Group 160 and group 170 may implement distinct governance models. Engine 130 applies rules 140 in implementing group 160, and applies rules 150 in implementing group 170. For example, engine 130 may recognize when votes are necessary in accordance with a governance requirement, track the progress of the vote (or decision by fiat), recognize a decision when made, send messages, notifications and announcements to members when necessary and implement the decision when made.

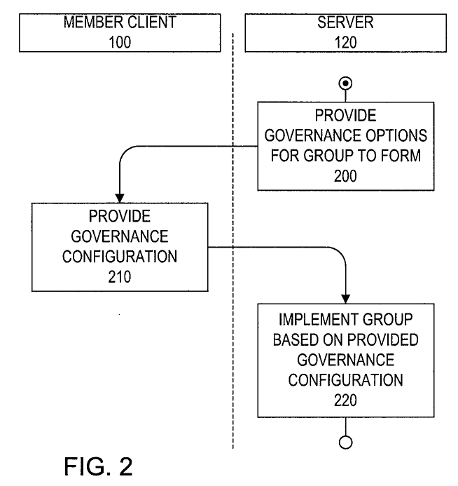

The governance model to be associated with a particular group may be configurable by a user at the time of forming the group, as illustrated in the embodiment of FIG. 2. In the illustrated embodiment, server 10 provides (step 200) client 100 with several configurable governance options to be associated with the new group. The options may be associated with a plurality of governance models for example. Upon the user providing (step 210) a governance configuration via client 100, server 120 implements (step 220) an online social networking group based on the governance configuration provided by the user. The provided configuration may specify one of the plurality of governance models under which the newly formed group is to be managed.

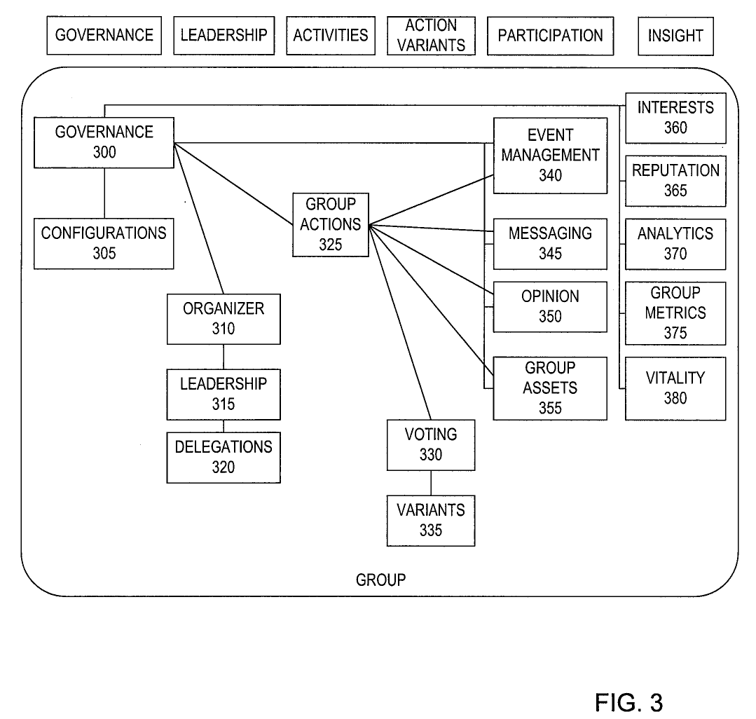

FIG. 3 illustrates an example of an architecture of a group. In the illustrated embodiment, the group is structured according to aspects of governance, leadership, activities, action variants, participation and insight.

Under the governance aspect of the group architecture, governance 300 refers generally to the leadership, rules and processes, activities, and action variants which structure the interactions and relationship of the members and group with other entities in the system. A governance model generally refers to the collection of rules embodied in a persistent state whereby a common record can be used one or many times within the system to establish how groups are managed. A model can be created through user selection or through a pre-existing common record, or template, that can be configured for use and modified, for example.

The rules and processes can provide the structure for how work is conducted in the online group. This may include, for example, group creation, conducting business within the group, and additional rights bestowed upon a member within the other features of the system. The governance may be organized on governmental models for example, with each model defining how decisions are made within the group. Models may also be configured to be representative of the scope of real-world organizations. Within a model there can be rules and attributes.

Configurations 305 refers generally to user selectable elements that can alter or change the governance model and how the group and group members interact under the model.

The system can enable the user to register at least one pseudonymous identity by which the user is to be known to the newly formed group. An example of a pseudonymous identity management system may be found in U.S. Pat. No. 7,043,760, entitled “SYSTEM AND METHOD FOR ESTABLISHING AND MANAGING RELATIONSHIPS BETWEEN PSEUDONYMOUS IDENTIFICATIONS AND MEMBERSHIPS IN ORGANIZATIONS,” which is herein incorporated by reference.

The system can also enable the user to provide additional information about the group to be formed; such data may be referred to as group attributes. Examples of group attributes include group name, logo, colors, and branding. The system may also enable the user to provide a membership message to be sent to the user. An example of a membership message could be an invitation for users to join a group. Additionally, the user may be provided with the option of filling out lists of classes of data: examples may include tags, interests, brands, charities, or group selected classes of data. If the group is being tied to an existing group or website, the user can provide a link to the group or website. The user may also be presented with a choice of nouns to describe what the user wants to refer to the group as (e.g., group, clan, union, gang, tribe, fraternity, sorority, association) and what the user wants to call its members (e.g., members, tribesmen, brothers, sisters, guild members). If desired, the user may provide custom labels. In subsequent interaction with the group, the system can use the chosen words whenever appropriate.

Under the leadership aspect of the group architecture, organizer 310 refers generally to the group member who founded the group and who by association may have certain rights and responsibilities of leadership.

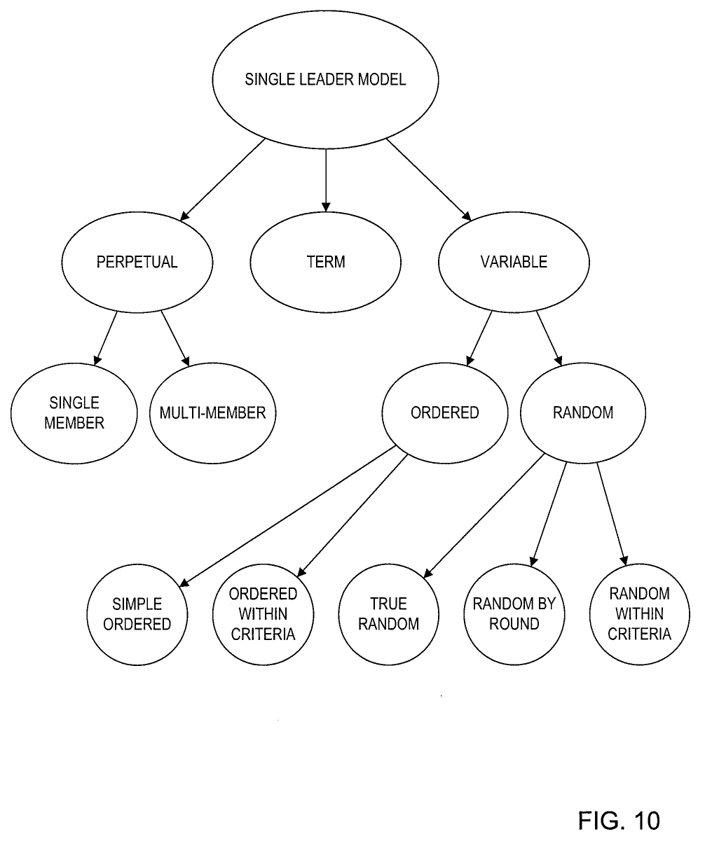

Leadership 315 refers generally to who can change the way a group looks or the membership of the group. The leadership may be established based on the type and structure of leadership desired. This may include, for example, no leader, single leader, and multi-leader models as described below in connection with FIGS. 10-12. By default the organizer of a group can be designated the leader.

Leadership may be a defining characteristic difference between governance models. For example, in models where there is only a single leader, it is the leader who makes all decisions. In models where there is no leader but the group supports voting for decision making, members of the group have the responsibility to vote on group activities and business.

Delegations 320 refer generally to assignments by an organizer or leader of leadership rights, roles, actions and responsibilities to one or many members, committees, sub-committees, groups, or sub-groups.

Under the activities aspect of the group architecture, group actions 330 refer generally to group business. Group business may include approving or disapproving a request for group membership, limiting member rights, and changing group attributes for example. Leaders can sanction members in some governance models. Examples of sanctions may include removal from the group, a probation on activities, or group disgrace.

For instance, removal from the group may refer to a process from which a user's membership in said group is revoked. All rights, responsibilities, and group privileges can be removed from the user and group access can be prohibited. Removal from the group can be permanent or temporary.

Probation may be time-restricted—the maximum time possible can be configurable as an option for the group organizer or leaders. During probation for example, the member may be permitted to view the activities in the group and continue to be a member of the group, benefiting from privileges bestowed upon a member. Such privileges may include, for example, profile listing in the group directory or third-party validation as a legitimate member of the group. When sanctioned, however, the member may not be permitted to participate in the ongoing business of the group. Examples of such business may include communicating with the group (e.g., via forums, chat, messaging), voting, and group related activities. Probationary status may be invoked automatically for new members in a group. This form of probation is not punitive, although the result is the same. This feature can be a group setting managed by the leadership or organizer.

Under the action variants aspect of the group architecture, voting 330 refers generally to the question and group response to group related business that may materially or immaterially impact the group.

Variants 335 refers generally to any element of the system that can be changed by value, selection, or de-selection to change the behavior, usage, or capabilities in the system. Examples may include durations for votes, quorum requirements, and selection of tools within a group.

Under the participation aspect of the group architecture, event management 340 refers generally to the creation, display, acceptance or declining of group related events. These events can be visualized as a list, calendar, Gantt chart or other method.

Messaging 345 refers generally to one-to-one or one-to-many communication between member and groups.

Opinion 350 refers generally to the polling or survey of members based on their preference regarding a subject or topic.

And group assets 355 refer generally to any digital asset. Examples may include a logo image, digital photograph, video, audio, other rich media asset, executable computer program, document, text, etc.

Under the insight aspect of the group architecture, interests 360 refer generally to the consolidated reporting, analytics, and visualization of data and group activity related to member and group interest and activity related to such interest within the system.

Reputation 365 refers generally to a value of a member's perceived image based upon that member's system activity, actions, and interactions.

Analytics 370 refers generally to critical analysis of group related data, usually over time, including key statistics, group metrics, and vitality for example.

Group metrics 375 refers generally to key statistics of the group, including number of members in a group, time since group founding, and amount of group activity for example. Group metrics 375 can also provide the group with the ability to define their own metrics and dimensions to enable the capture, reporting, and analysis of group measurements.

And vitality 380 refers generally to the group's progress and activity as compared against other similar groups. Vitality 380 can measure the maturity stages of the group and the vitality of relationships with other groups or communities based on, for example, measurement and analytics associated with group formation, growth, participation, issues/events resolved and comparison to historical baselines or best practice metrics.

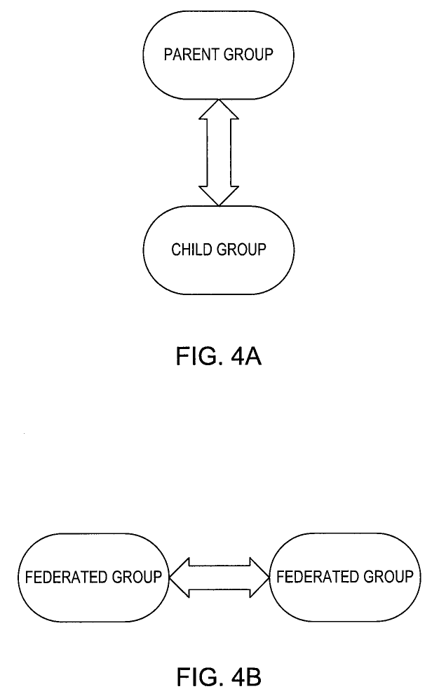

FIGS. 4-9 provides examples of different group structures and types of relationships between groups. As illustrated in FIGS. 4A and 4B, groups can maintain a variety of relationships with other groups. There are two types of relationship in the illustrated embodiment: parent/child and federation. Any change to a group's inter-group relationship status can be considered a group action and could follow the governance protocols enabled for the group.

In most cases, relationships are consensual: the two groups agree to be in a relationship with one another, and if either group denies the relationship request, the relationship is not established. Similarly, already existing relationships cannot be modified without the consent of both parties. However, some relationships may be ended without the consent of both parties. Only one relationship between two groups may be in effect at a given time. For example, group A may not be both federated and parenting with group B.

As shown in FIG. 4A, the parent/child relationship is a vertical relationship, the parent group directly above the child. In this embodiment, the parent group has power over the child group. The parent's powers can be exercised when a member of the parent group is viewing the child group's vital statistics page for example. Each power the parent group has over the child group may be represented by a link on the child group's vital statistics page, which redirects the user to whatever application for which the user has permission.

Being a parent may confer a wide range of powers over the child group. Sufficiently empowered members of the parent group may have extensive monitoring privileges over child groups: for example, parent moderators may examine the child's applications and modify the contents therein. Parent groups may also require that child groups defer to them on specific matters, essentially granting the parent group veto power over the child group. Parent groups may make arbitrary changes to the child group's attributes, may grant invitations to other members for the child group, may sanction or expel members of the child group, may upload or delete files in the child group's filing cabinet, and make changes to the child group's main page. Finally, the parent group may lock the child group, effectively ending the child group's autonomy.

When the parent/child relationship is first established, the parent group may decide which of these powers it wishes to have over the child group, checking as many or as few options as the creator wishes. The relationship will be created with these powers in effect. The parent may change these powers at any time, but the child group may be notified any time the list of powers is modified in any way.

The child group has no such power over the parent group. The child group may vote to emancipate itself from the parent group, breaking the parent/child relationship entirely. However, the child group may not even take this action if it has been locked by the parent group.

As shown in FIG. 4B, the federation relationship is a horizontal relationship, the two groups side by side on the same level. In this embodiment, both groups are in the same group network, but neither group has direct power over the other. In a group network, two groups at the same level of organization may be federated with one another for example.

An advantage of federating would be to enhance communication between groups. Federated groups could choose to share membership rosters or filing cabinet permissions, for instance. Federation could also be used in addition to and/or as an alternative to parent/child subgrouping. Federated groups can guarantee that neither group wields power over the other. Any combination or nesting of groups is possible.

Federated groups can grant permissions to one another to access one another's applications. For example, a group can share its message boards or filing cabinet with a federated group. In one embodiment, clicking a federated group on a system page may select the group's name, from which a sufficiently empowered group member can select applications which can be visible to members of the targeted federated group. This action can be governance compliant, not requiring the consent of the second party. A member of a group granted permissions by one of its federated groups may exercise these permissions when viewing the granter's vital statistics page, for example. Each permission granted to the member may be represented by a link redirecting the member to whatever application is designated as shared by the granter.

In one embodiment, groups may be federated in a manner reflecting real-world relationships between organizations, such as in a keiretsu. For example, two or more groups without parent groups can become federated to represent a consortium, joint venture, committee of groups, etc. The federated groups may also become a supergroup, in which a group is created to become the parent of the federated groups, none of whom have parents. This can be accomplished by establishing a parent/child relationship, with the subordinate groups being part of the federation. For instance, suppose A and B are federated, and then C becomes the parent of A. C therefore would become the parent of B. Federating groups places them on the same level in the same network, creating a new group above that binds the federated groups together.

The formation of such a group can be widely varied. For example, if a group is federated with other groups and accepts a parent group, before a new parent relationship can be established all groups federated with the group in question can be notified that the initiating group is trying to form a supergroup, or hub group. The federated groups can confirm the request in accordance with their established governance protocols before the new parent/child relationship can be established.

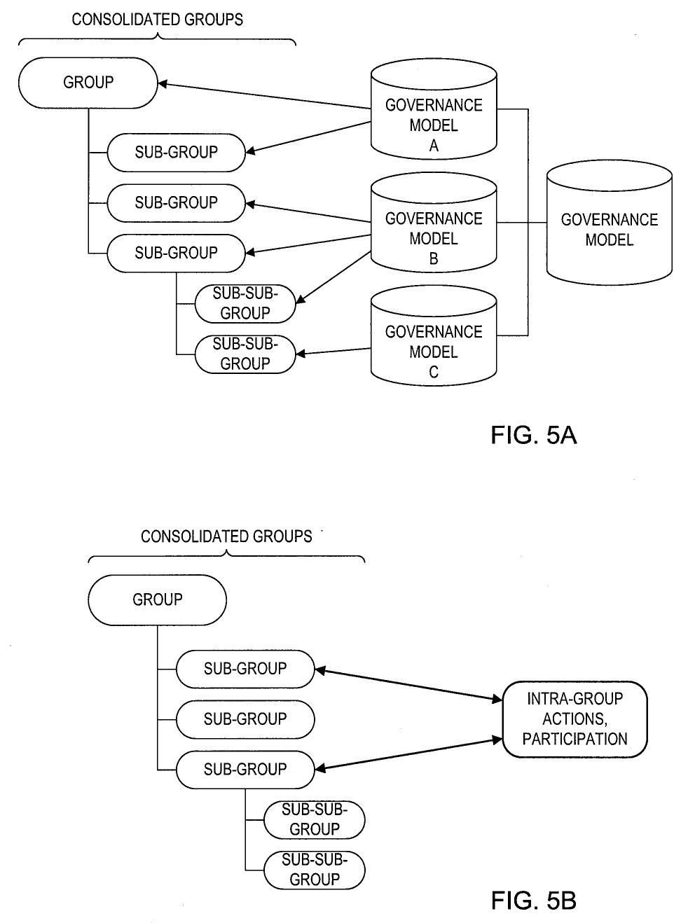

FIG. 5A illustrates an example of a groups consolidated by parent/child subgrouping. As illustrated in this embodiment, the system can apply distinct governance models to any of the consolidated groups. As shown in FIG. 5B, intra-group actions and participation can be implemented between any of the consolidated groups.

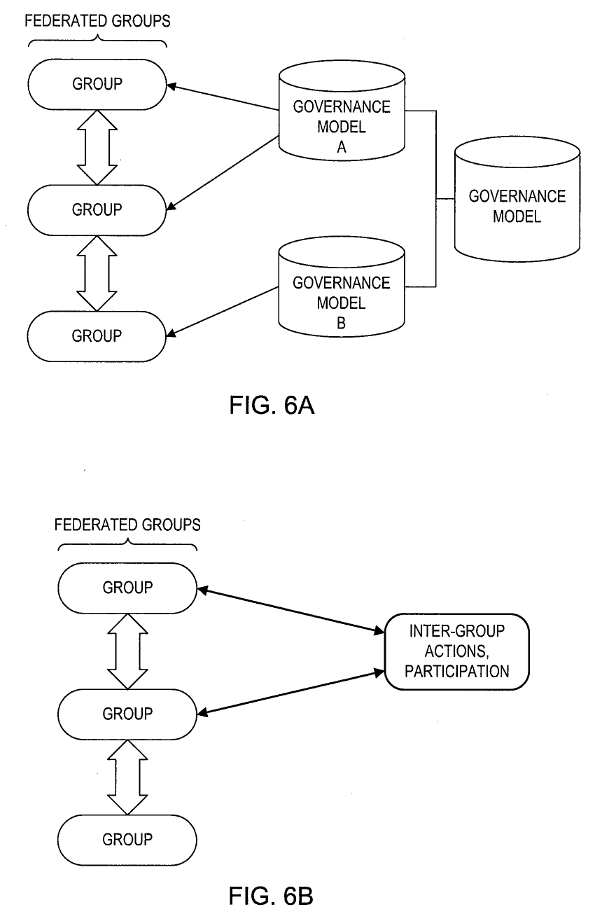

Similarly, FIG. 6A illustrates an example of federated groups to which the system can apply distinct governance models. As shown in FIG. 6B, inter-group actions and participation can be implemented between any of the federated groups.

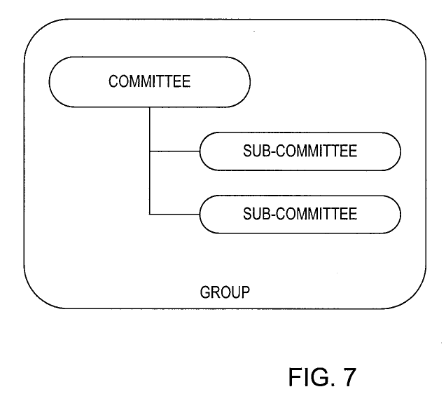

FIG. 7 illustrates an example of a group sub-structure in which certain members can be associated with committee and sub-committees. The committee sub-structure may be defined by the governance model under which the group is managed.

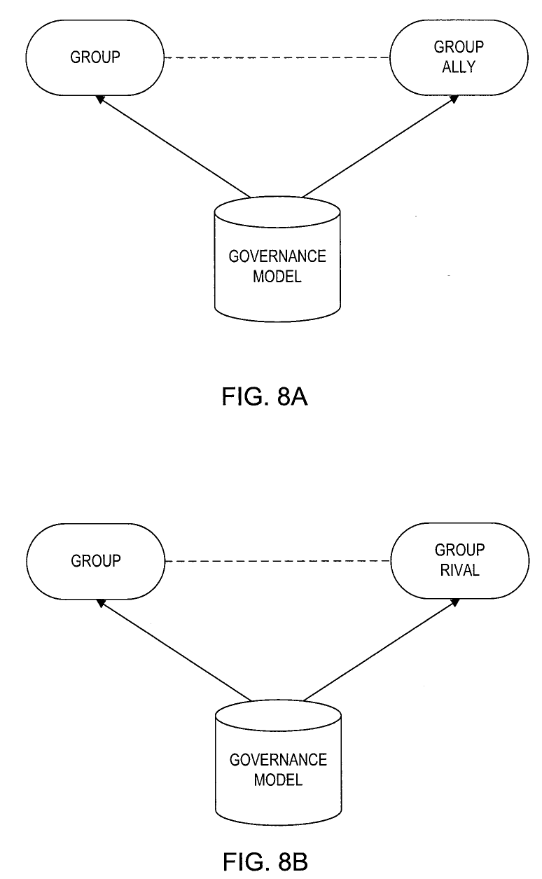

FIGS. 8A and 8B illustrate examples of relations between group allies and rivals. The system enables alliances and feuds to be created as relationships among the groups. For example, a group may identify an alliance by the relationship “Supporters of:”, and a feud may be identified by the relationship “Competes with:”. In one embodiment, each group may have a few of its longest-standing relationships displayed on its main page, with separate headings for “Parent of:”, “Child of:”, “Federated With:”, “Supporters of:”, and “Competes with:”. A full list of relationships may be viewable on a separate page.

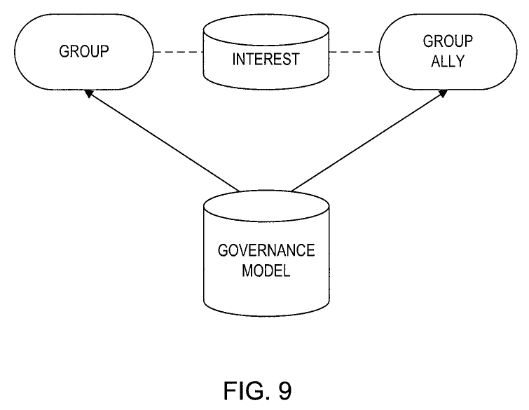

FIG. 9 illustrates an example of a relation between groups based on interest. Groups can be cross-referenced based on group interest. This supports discovery, in that groups can be discovered, compared, and contrasted based upon matching interests.

FIGS. 10-12 provide examples of governance models that may be broken down into three classes-single leader, multi-leader and no leader-in the illustrated embodiments.

As shown in FIG. 10, a single leader model may include a perpetual, term and variable model. Each model may have the following governance properties in accordance with the illustrated embodiment:

Under the perpetual model, a single leader can provide the leadership role of a group until the leader resigns or is removed from leadership responsibilities by a super-majority of group members. A super-majority by default can be established as a particular voting quorum such as ⅔, but can be configurable on a per group or sub-group basis. Removing the leader from power does not require the leader to be removed from the group. A special election can be conducted to elect a new leader. The leader can take action directly and choose to accept or deny any request from a group member, at which point the system takes the action automatically. The first leader can be the organizer of the group.

The perpetual model can include a single member and multi-member model. In the single member model, the single member of the group may represent an individual such as a celebrity for example. In the multi-member model, the members may represent collective users such as fan club for example. These models can be non-voting without member requests, and may be established to provide “fans” or “supporters” rosters instead of a member roster. These models can have participation tools like a blog serving to focus attention on a personality or entity for example.

Under the term model, a single leader can hold power for an established term period. The leader comes to power through self designation or elections. The first leader can be the organizer of the group.

Under the variable model, a single leader can provide transient leadership of a group that has a pre-established method for regular and constant changes in leadership. Powers may be passed to a different member based on an established time period. Unlike other single leader models, the change in leadership does not require or use an election or vote. Examples of methods and processes for leadership changes can include the types illustrated in TABLE 1.

TABLE 1

| Model Type | Description |
|---|---|
| Simple Ordered | Leadership changes based on an ordered |
| | member roster. The membership roster |
| | order can be established for example |
| | through alphabetical sorting based on first |
| | or last name, order by seniority, or reverse |
| | order based on existing criteria. |
| Ordered Within Criteria | A member must be in the group for a |
| | certain period of time before being eligible |
| | for leadership. Another example would be |
| | requiring a certain amount of reputation as |
| | described below. |
| True Random | The leader is selected completely at |
| | random. |
| Random By Round | The leader is selected randomly from |
| | members who have not been a leader |
| | since others have been |
| Random Within Criteria | The leader is selected randomly from a |
| | pool of members who meet a certain |
| | criteria (as described above). |

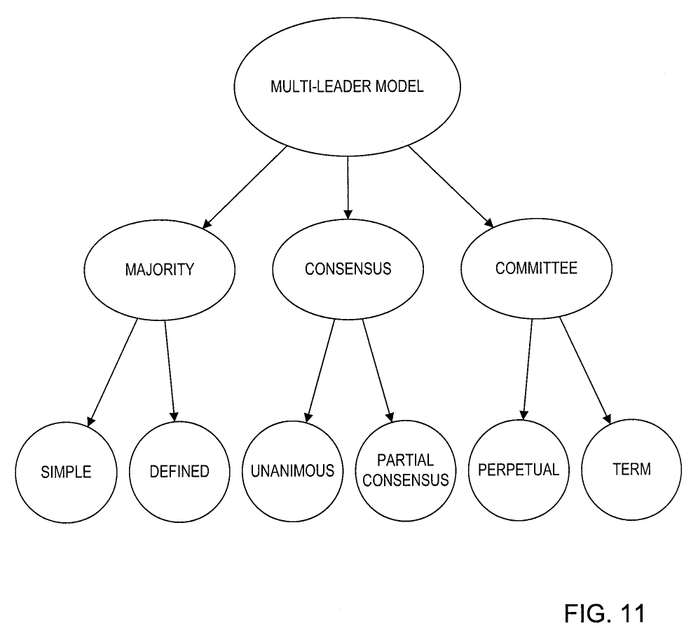

As shown in FIG. 11, a multi-leader model may include a majority, consensus and committee model. Each model may have the following governance properties in accordance with the illustrated embodiment:

Under the majority model, a majority vote can be required on all actions or delegations. The majority model can include a simple and a defined majority model. The simple majority model can require a greater than 50% majority to accept an action request; whereas the defined majority model can defaulted to a particular majority, such as ⅔ (greater than 66%), but may be configurable based on group preference. Each group request can go to a vote; example requests include a membership application, member sanction, or role delegation. Quorum for voting can be established through group settings and is the minimum number of members necessary to constitute a valid decision. The time period in which a vote is alive while trying to achieve a quorum and/or majority can also be specified. These settings may have default values. Decisions can be established as a standard or important decision, such that an important decision requires a larger amount of group participation to constitute a valid decision.

Under the consensus model, a consensus can be required on all actions or delegations. The consensus model can include a unanimous and a partial consensus model. The unanimous consensus model can require unanimous approval for a request or action to pass. The partial consensus model can enable a user to vote “no” or abstain without forcing a vote to fail. In this model, the system enables users to have veto powers. If a specified time period expires without a veto being cast, then the request or action passes. Configuration settings may include specifying the time period for votes for example.

Under the committee model, a committee can provide a sub-structure to enable leadership of a group by a few. The members of a committee can vote for a sub-group of leaders who make the actual decisions. Attributes of committees may include the number of leaders and the term length for each leader for example. The committee model may include a perpetual committee model and a term committee model. In the perpetual committee model, the leaders can provide the leadership role of a group until constituent members request a recall election or provide a vote of no confidence, which if successful can terminate the serving committee and trigger a new election. In the term committee model, the leaders can hold power for an established term period. The structure of committees may be widely varied.

For example, in one embodiment, both the chair and non-chair committee members can do anything just by taking a direct action-aside from certain configuration option changes and dissolution for example. They only have to vote when a non-committee member petitions them. The only systematic purpose of the chair in this embodiment is to break ties. In another embodiment, any committee member can decide a petition with a YES or NO.

In another embodiment, the chair can do anything by just taking an action. Committee members have to create a vote to do anything, and non-committee members petition the committee for anything. These petitions can either be decided by a committee vote or by a YES or NO from the chair. In another embodiment, the YES or NO is disabled.

In a further embodiment, both the chair and non-chair committee members have to create a vote to do anything. Non-committee members petition the committee for anything. These petitions are decided by a committee vote. The only systematic purpose of the chair in this embodiment is to break ties or veto.

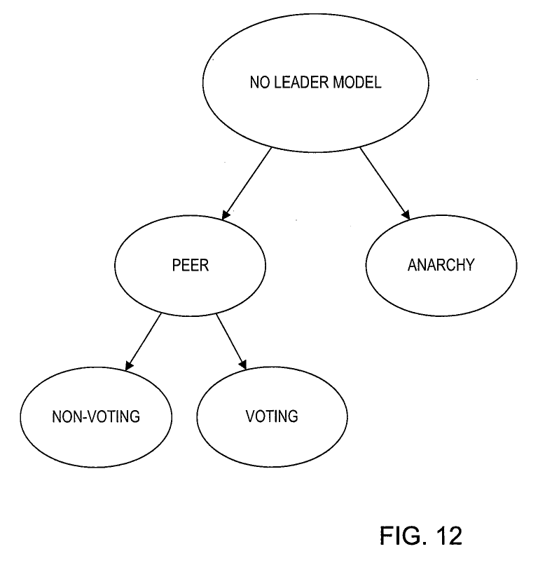

As shown in FIG. 12, a no leader model may include a peer and anarchy model. Each model may have the following governance properties in accordance with the illustrated embodiment:

Under the peer model, all members are equal. Any member can make decisions to change anything about the group. Peer groups cannot chose to convert to another type of governance model. Peer groups can be established as voting or non-voting groups.

Under the anarchy model, no governance state exists. Any member can make any decision at any time. Anarchies can also adopt alternate governance models, which may be the only action where members of anarchies vote. Option and attribute changes can be open to all members.

TABLE 2 illustrates an example governance action table in accordance with the illustrated embodiments:

TABLE 2

| | | | | | Changing | | Single | |
|---|---|---|---|---|---|---|---|---|
| | Single Leader | Multi-Leader | Committee | Consensus | Leader | Peer | Member | No Leader |
| Membership | Leader decides | All members | Committee | All members | Leader | Automatic | No | Automatic |
| | | vote (except | decides via | vote, | decides | approval | additional | approval |
| | | sanctioned | vote | member veto | | | members | |
| | | members) | | ability | | | allowed | |
| Remove | Leader decides | All members | Committee | All members | Leader | N/A | N/A | Member may |
| Member | | vote (except | decides via | vote (except | decides | | | resign, but can |
| | | sanctioned | vote | sanctioned | | | | not be removed |
| | | members) | | members) | | | | by membership. |
| Sanctions | Leader decides | Votes on | Committee | Members | Leader | N/A | N/A | N/A |
| | | sanctions | decides via | vote-acts | decides | | | |
| | | | vote | like | | | | |
| | | | | democracy in | | | | |
| | | | | this case | | | | |
| Pardons | Leader option | N/A | Committee | Membership | Leader | N/A | N/A | N/A |
| | | | vote to pardon | vote, | decides | | | |
| | | | | member veto | | | | |
| Attribute | The leader may | Members may | Members | Member | Leader | N/A | Member | Member |
| Changes | change any | propose a | propose and | proposes, | decides, | | decides. | decides, model |
| | attribute (logo, | change which | the committee | member veto | except | | | change requires |
| | motto, name) | is voted on by | votes. | | model | | | vote. |
| | including the | the other | | | change | | | |
| | governance | members. | | | requires vote | | | |
| | model | | | | | | | |
| Requests | N/A | Members may | Members may | Member | Any member | N/A | Member | N/A |
| | | propose any | propose any | proposes, | may propose | | decides. | |
| | | permitted | permitted | member veto | a change. | | | |
| | | action, such as | action, such | | | | | |
| | | sponsoring | as sponsoring | | | | | |
| | | another | another | | | | | |
| | | member, | member, | | | | | |
| | | sanctioning a | sanctioning a | | | | | |
| | | member or | member or | | | | | |
| | | suggesting a | suggesting a | | | | | |
| | | change to a | change to a | | | | | |
| | | group's | group's | | | | | |
| | | attributes. | attributes. | | | | | |
| | | | The proposal | | | | | |
| | | | queues up for | | | | | |
| | | | a committee | | | | | |
| | | | vote. | | | | | |
| Split Group | Yes, requires ⅔ | Yes, requires ½ | Yes, requires | Yes, but a | Yes | No | N/A | No |
| | vote | vote | ½ vote | single no | | | | |
| | | | | vote kills it | | | | |
| Remove | Yes, requires ⅔ | No | Yes, requires | No | Yes, but if | No | N/A | N/A |
| Leader from | vote. The | | majority and | | they can't | | | |
| Power | removed leader | | removes the | | get the ⅔ | | | |
| | is not removed | | entire | | vote and | | | |
| | fromthe group. | | committee. | | necessary | | | |
| | That requires a | | Committee | | quorum by | | | |
| | separate motion. | | members stay | | the end of | | | |
| | | | in the group | | the day, the | | | |
| | | | after removal. | | point is | | | |
| | | | | | moot. | | | |
| Leader | Yes | N/A | Yes | N/A | Yes | N/A | Yes, but | N/A |
| Resigns from | | | | | | | effectively | |
| Post | | | | | | | disbands | |
| | | | | | | | group | |
| Quorum | N/A | Configurable | Configurable | Configurable | Configurable | None | 1 | N/A (except for |
| | | Default: 25% | Default: 25% | Default: 25% | Default: 25% | | | governance |
| | | | | | | | | change or group |
| | | | | | | | | dissolution) |
| Dissolution | ⅔ vote and | ⅔ vote and | ⅔ vote and | ⅔ vote and | ⅔ vote and | ½ vote | Immediate | ½ vote and |
| of Group | quorum | quorum | quorum | quorum | quorum | and | action- | quorum |
| | | | | | | quorum | single vote | |
| Elect a | N/A | N/A | Yes | N/A | N/A | N/A | N/A | N/A |
| committee | | | | | | | | |
| Elect Leader | Majority vote | N/A | N/A | N/A | N/A | N/A | N/A | N/A |
| | invoked if | | | | | | | |
| | leaderresigns or | | | | | | | |
| | is unable to | | | | | | | |
| | continue in role. | | | | | | | |
| Change | ⅔ vote and | ⅔ vote and | ⅔ vote and | ⅔ vote and | ⅔ vote and | ½ vote | Immediate | ½ vote and |
| Governance | quorum | quorum | quorum | quorum | quorum | and | action- | quorum |
| Model | | | | | | quorum | single vote | |
| Configurable | Governance | Time period | Time period | Time period | Governance | N/A | Anything | Anything |
| settings and | options, roles | between | between | between | options, | | | |
| delegations | and | repeated vote | repeated vote | repeated | roles and | | | |
| | responsibilities. | requests. Until | requests. Until | vote | responsibilities. | | | |
| | | time period is | time period is | requests. | | | | |
| | | up, a vote | up, a vote | Until time | | | | |
| | | cannot be | cannot be | period is up, | | | | |
| | | repeated. | repeated. | a vote | | | | |
| | | | | cannot be | | | | |
| | | | | repeated. | | | | |

In a particular embodiment, different rules may be enabled when a group has five members or less. These rules can be configurable in an administrative interface of the system. For example, from the time a group is created until the group has more than five members, a group may run in “Small Group Mode” (SGM). While in SGM, groups with less then five eligible members would have problems with votes requiring majority and super majority, such as in connection with important questions. The system may handle SGM differently depending on the governance model. Once a group's membership is large enough to sustain group interactions, the system may prompt the leader(s) to adopt one of the governance models previously selected or alternatively to choose a governmental model to manage the group going forward. This change may not apply to open votes but only new votes.

In the embodiments described above, for instance, in a multi-leader model all users may have leader rights and responsibilities-with the exception of expelling anyone or sanctioning the group creator, who during this period can expel or sanction anyone. In a single leader model, only the leader may have leadership rights and responsibilities, no matter what size the group is. In a single member model, only the member/leader has leadership rights and responsibilities, no matter what size the group is.

Committee groups may be in SGM until the number of members is greater then or equal to the committee size. The first member or creator is the chairperson. The chairperson can unilaterally do anything in the group until committee size is met. The chairperson may invite members to join in two categories-one group of invites can be for committee members, and the other is for membership in the group but not the committee. During this time only the chairperson can perform group actions. The system can enable additional functions after SGM has been exited.

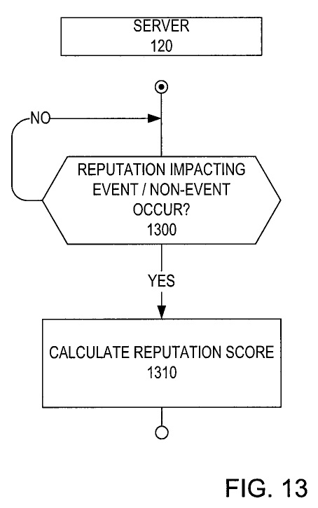

FIG. 13 illustrates an example of reputation score calculation process in connection with governance of a social networking group. In the illustrated embodiment, server 120 determines (step 1300) whether an event or non-event has occurred in the implementation of a group that may influence a reputation of a member or the group. If an event or non-event is determined to have occurred, server 120 calculates a reputation score (step 1310) for the member or the group.

For example, TABLE 3 illustrates system activity that may have an impact on user reputation in accordance with one embodiment:

TABLE 3

| Description | Value |
|---|---|
| Sanctioned | Negative |
| Expelled from group | Negative |
| Flagged with negative content | Negative |
| Removed from leadership | Negative |
| Flagged as manipulating system | Negative |
| Inactive User | Negative |
| Voting in group | Positive |
| Being nominated for a group role | Positive |
| Being elected for a group role | Positive |
| Association with other high reputation users | Positive |
| Accepted invitations from high reputation users | Positive |
| Creating a vote | Positive |
| Creating a group | Positive |
| Acceptance of submitted article | Positive |
| Inviting other users to system | Positive |
| High % yield of accepted invites | Positive |
| Being a group leader | Positive |
| Active group participation | Positive |
| Active participation in many groups | Positive |
| Leading a high reputation group | Positive |
| Active contribution to group publication | Positive |

The system may also provide incentives that come into effect once the reputation score of members or groups attains a certain threshold level. For example, one incentive may allow a member into a “premium group” such as a red carpet room or a private club. In another example, a group may be formed for only high reputation members.

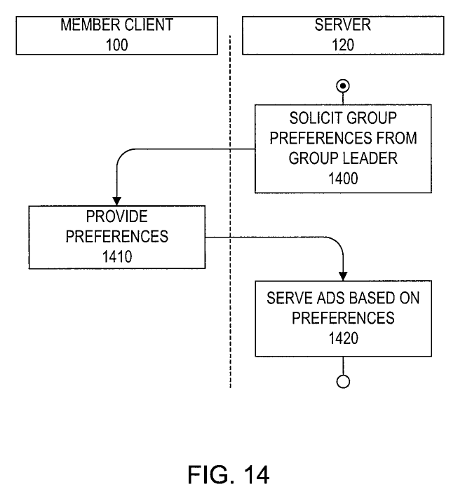

FIG. 14 illustrates an example of ad serving based on group preferences provided by a leader of a social networking group. In the illustrated embodiment, server 120 may solicit (step 1400) opt-in preferences attributable to a group from a leader of the group. Once the leader provides the preferences (step 1410), server 120 may serve ads (step 1420) to the members of the group based on the provided preferences. In other embodiments, the system can enable ad serving based on user preferences provided by individual members of the group.

The system may serve ads on a group's private and/or public home pages, and revenue resulting from the served ads may be shared with the groups. The leaders of a group may be required to provide a particular number of preferences, such as 10, although they may pick more or change their preferences at any time. The terms and conditions of the service may specify that the leaders are opting-in for their members.

The opt-in preferences screen may comprise a large taxonomy of subject areas which can be expanded to fine-tune preferences. Thus “sports” may break down into “football”, “skiing”, etc. This screen may allow a finer granularity in advertising preferences, such as allowing the groups to specify such things as language, region and age.

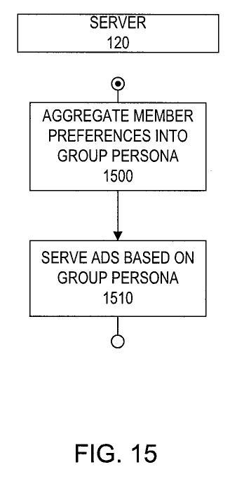

FIG. 15 illustrates an example of ad serving based on a social networking group persona. In the illustrated embodiment, server 120 may aggregate (step 1500) preferences of group members into a single persona for the group, and serve ads (step 1510) based on the group persona.

For instance, when a user account is created the user may be prompted to create facets of the user called a persona. The system can collect asserted labels including, for example, a user-asserted label where the user states something, a peer-asserted label where another user asserts something, and a third party-asserted label where a group or other organization verifies and makes an assertion. These assertions can be broken into classes, such as interests, causes, charities, and brands for example. The collection of labels across the classes in aggregate for a group may be referred to as a group persona.

Accordingly, the system can enable advertisers to bid against such classes of assertions. When an advertiser chooses a persona or group persona, the group sponsorship role (by default the leader in some embodiments) or persona (individual facet of a user) can have an ability to reject the advertiser. Advertising may exist in a variety of forms, such as graphical ad units, text ad units, group sponsorship, and branding for example. Ads served to third party publishers may be contextual based on tags and tag class. This provides explicit and implicit user persona contextual advertising.

The system can also enable advertisers to provide a customizable look and feel, such as by choosing colors and providing stylized images for example, in order to sponsor a group. This will change the look and feel for the user of that group. Additionally, the advertiser can have an ability to sponsor notifications in a user activity log. This enables the advertiser to communicate with a group. The advertiser can also have a variety of group applications that enable further communication. Advertisers can also sponsor a persona.

And as described above, monies earned through advertising and sponsorships of groups and personas can have revenue shared based on a business relationship.

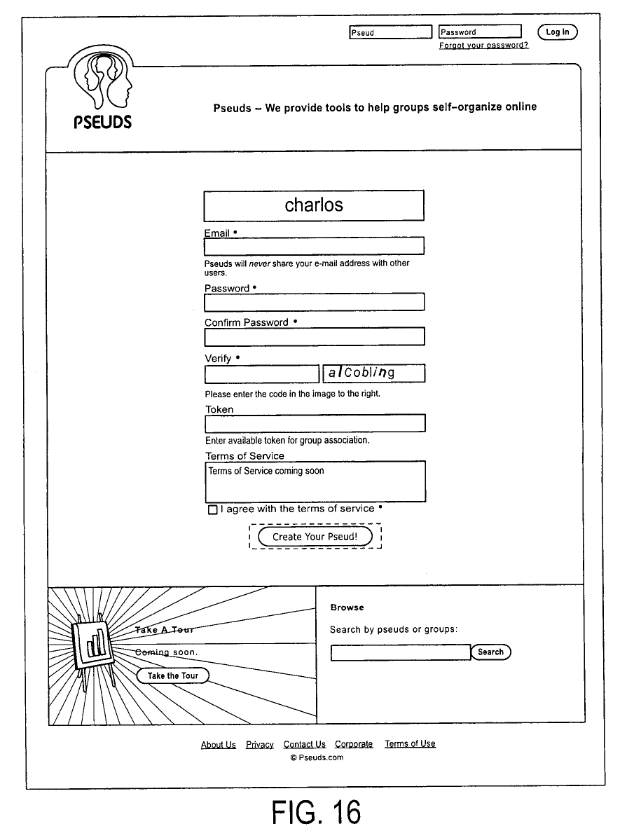

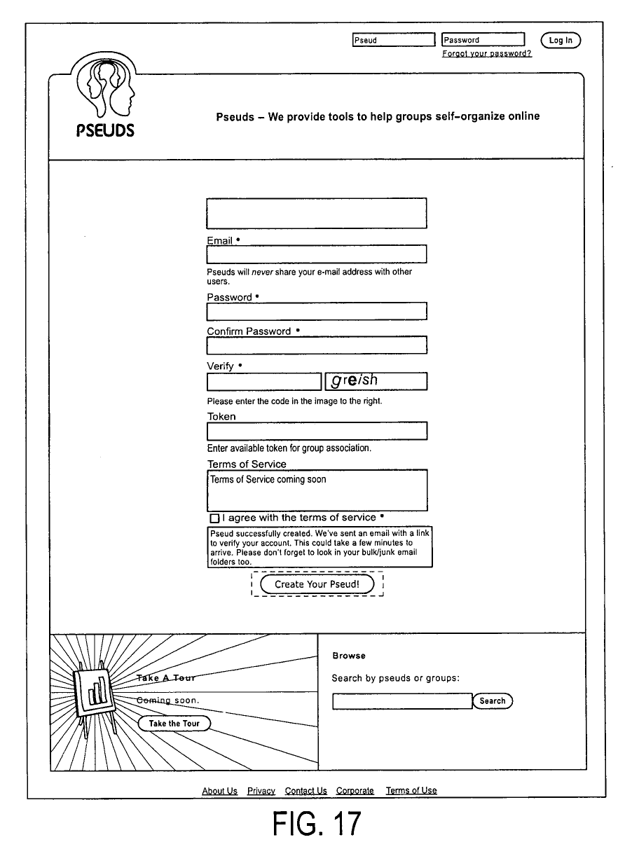

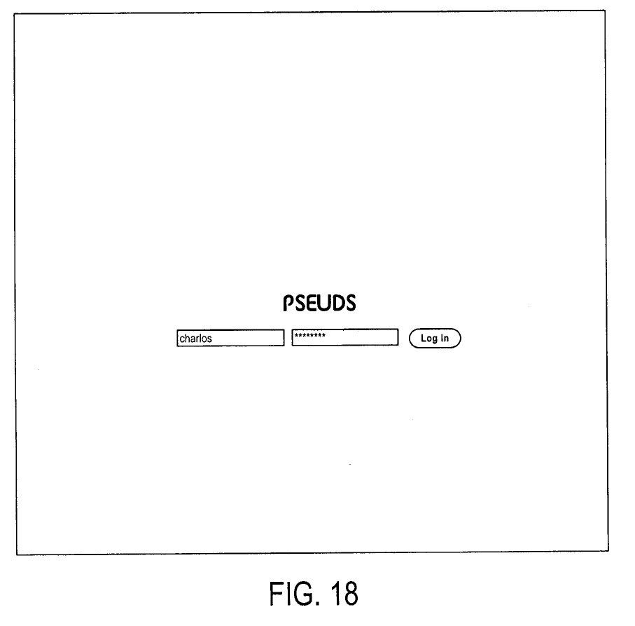

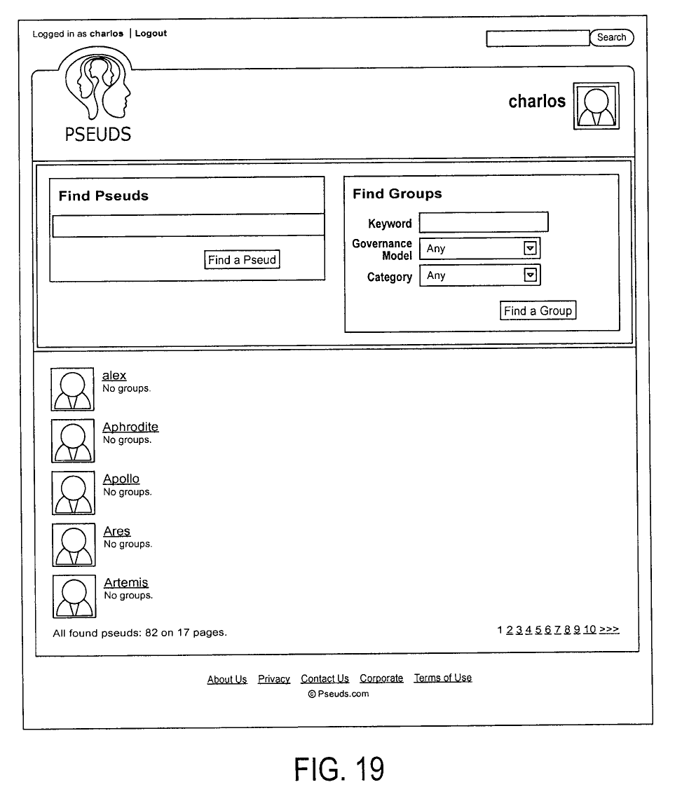

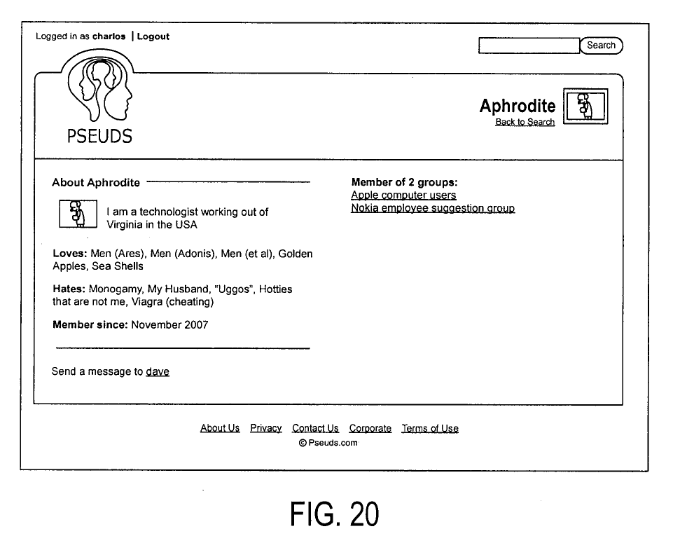

FIGS. 16-38 illustrate examples of one embodiment of a user interface associated with a multi-governance social networking system in one embodiment. FIGS. 16-19 illustrate screenshots associated with a user creating a pseudonymous identity to be used in connection with the multi-governance social networking system. In the illustrated embodiment, the system enables a registration process in which a user creates a pseudonym “charlos” (FIGS. 16 and 17) and logs in to the system under that pseudonym (FIG. 18). In this embodiment, pseudonymous identities associated with the system, groups and the site managed by the system are referred to as “pseuds”. The system enables the user to search (FIG. 19) and discover user-provided information about (FIG. 20) other registered users of the system.

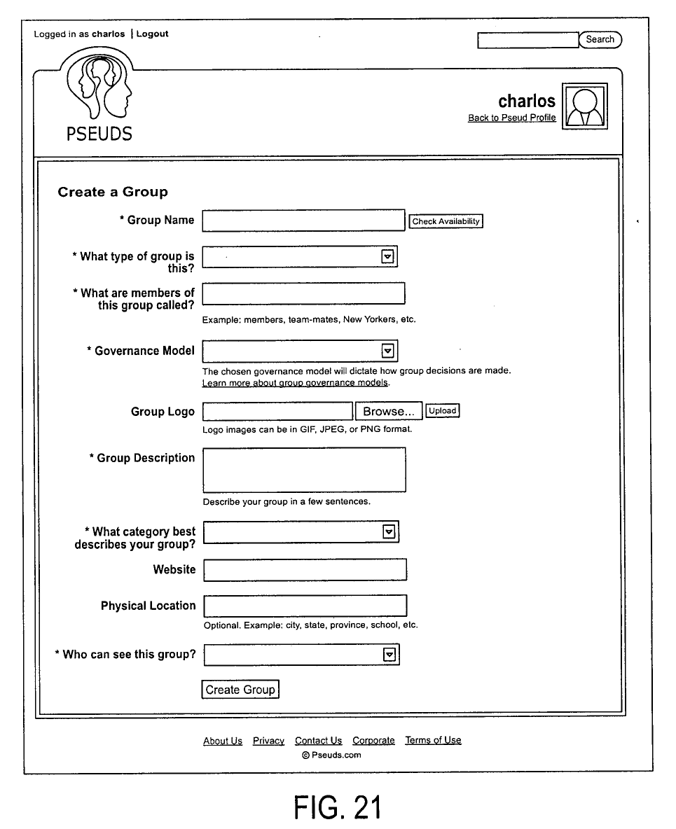

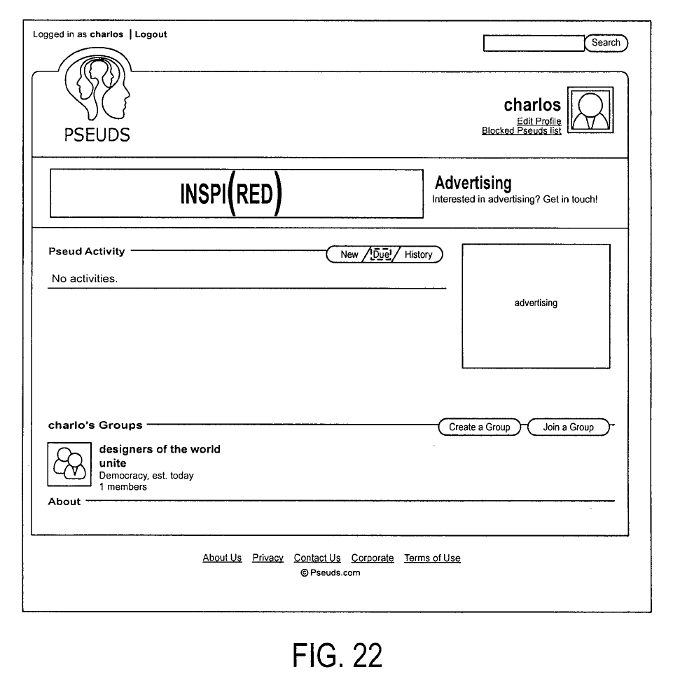

FIGS. 21-38 illustrate the user interface enabling the user to create and participate in a group of the multi-governance social networking system. In the illustrated embodiment, the system enables the user to create a group through a configuration screen (FIG. 21) that presents selectable options including the type of governance model under which the group is to be managed. Once created, the system can present the user with a list of groups (FIG. 22) to which the user belongs. In this embodiment the user chose to form a group labeled “designers of the world unite” under a democracy model. The user is the sole member of the newly formed group in the illustrated embodiment.

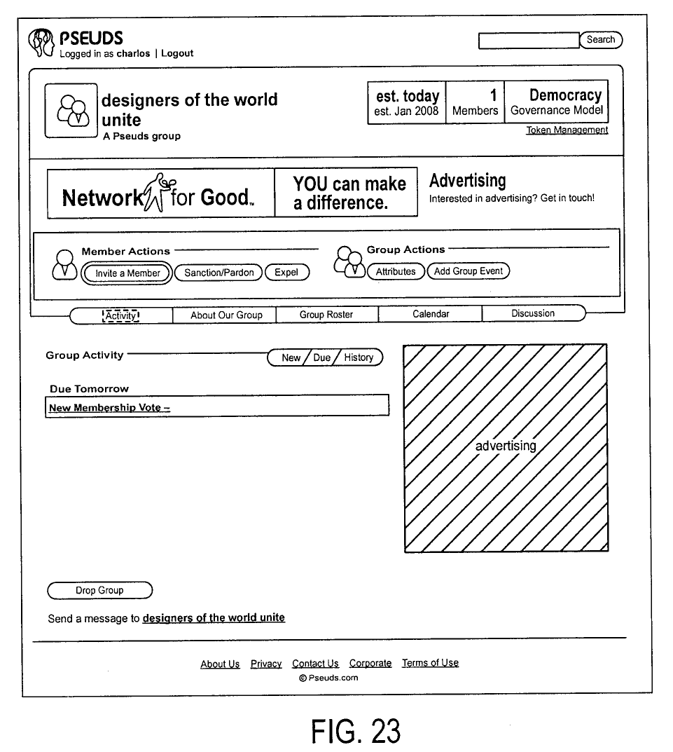

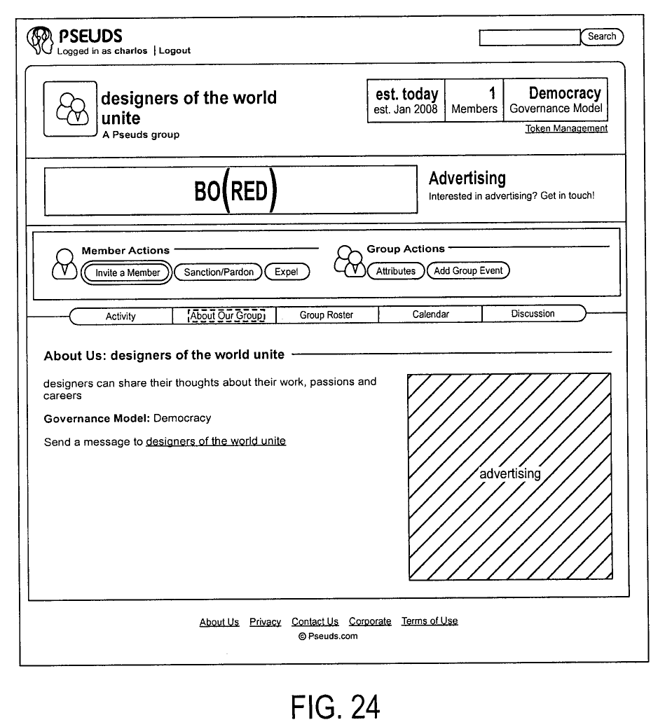

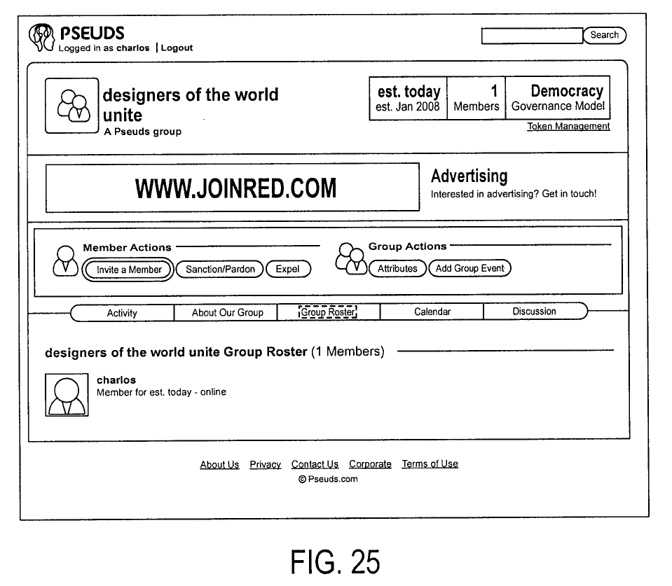

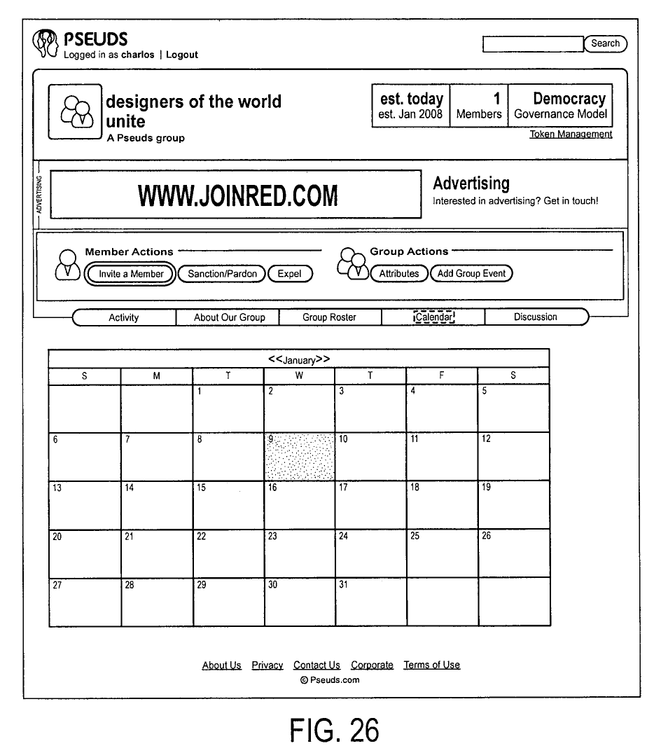

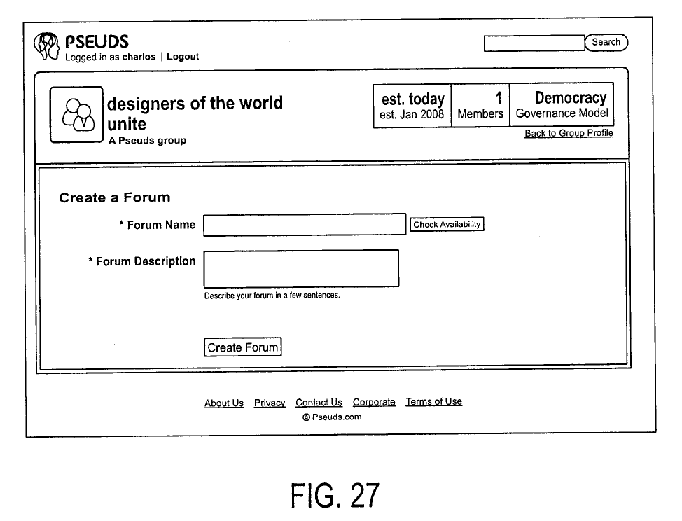

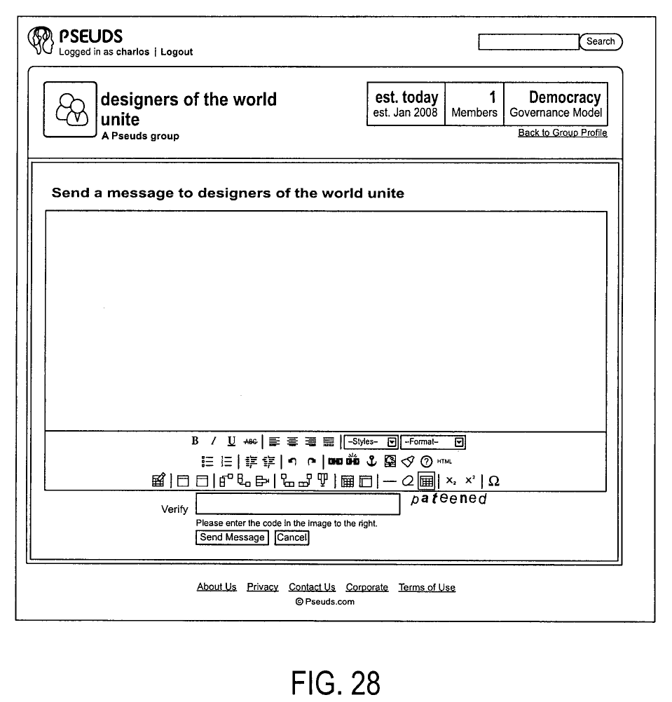

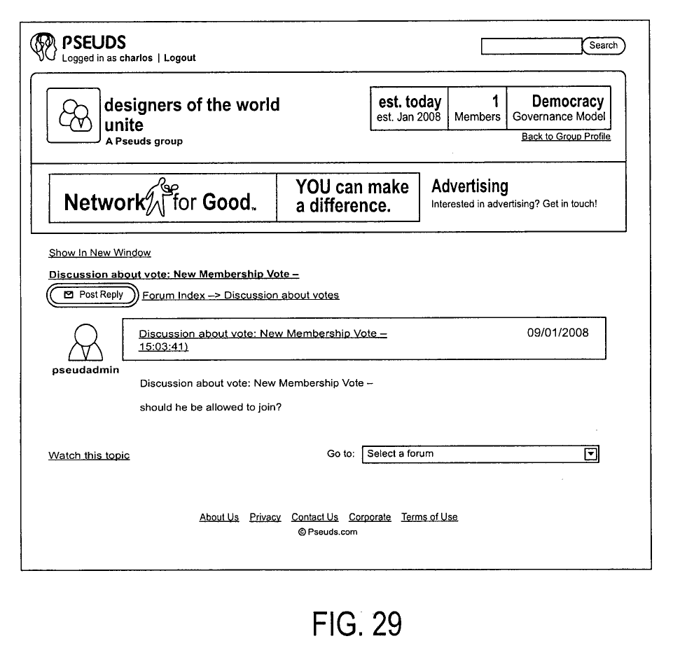

The system can also present information to a group member in connection with the group, including the group's activities (FIG. 23), information about the group itself (FIG. 24, the group's roster (FIG. 25) and the group's calendar (FIG. 26). The system enables the member to communicate with other group members, including through discussion forums. The system enables the member to create a discussion forum (FIG. 27) and send a message to other group members in connection with the forum (FIG. 28). As a result, the system can present a threaded discussion (FIG. 29) to the group members. In the illustrated embodiment, the member created a forum to discuss a new membership vote.

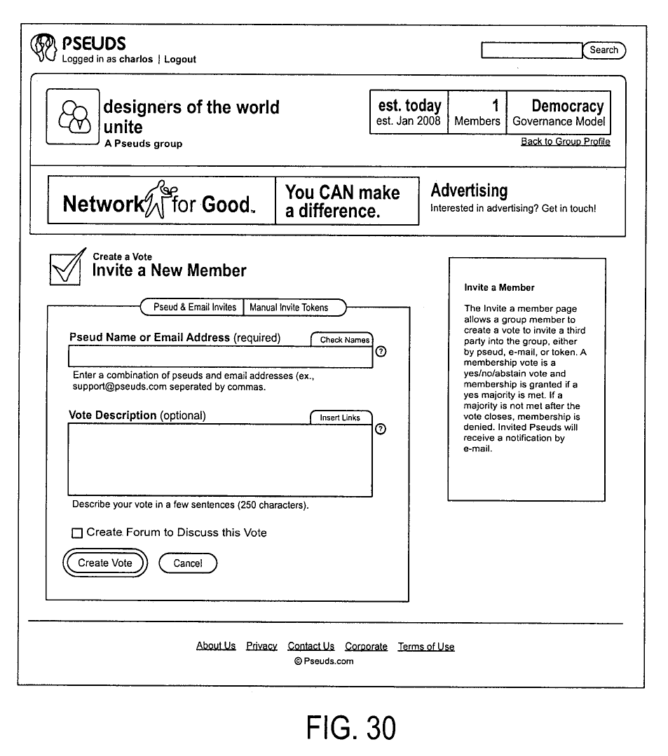

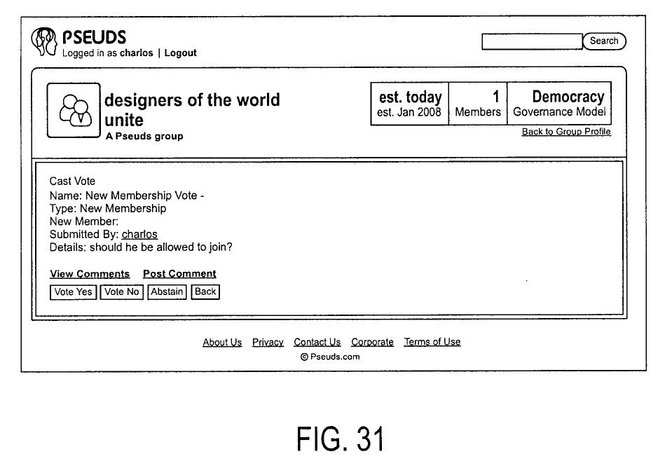

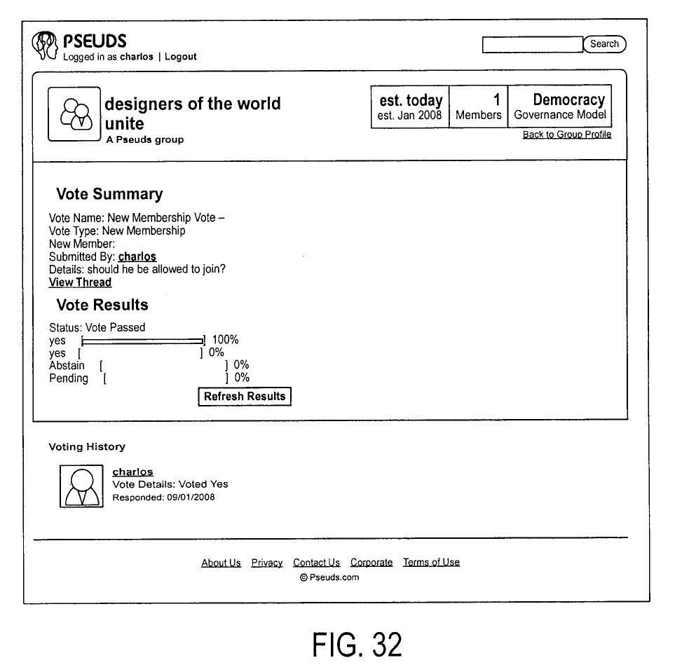

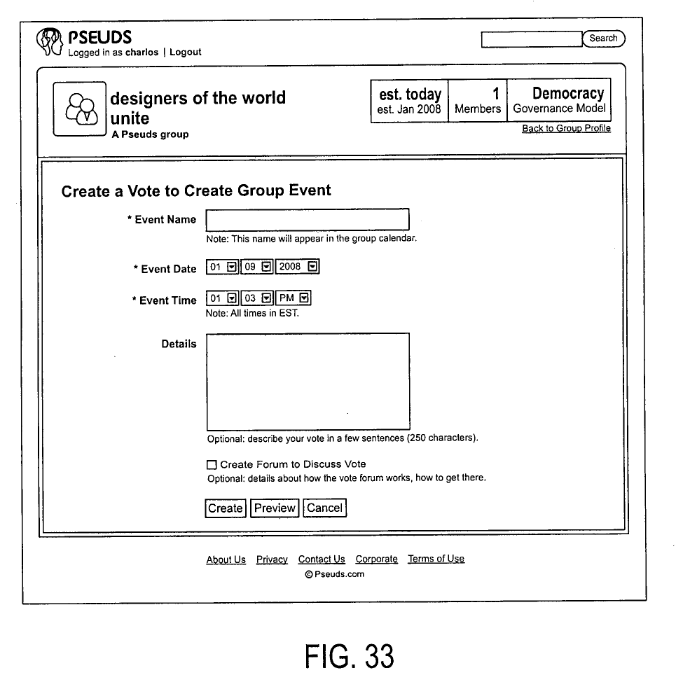

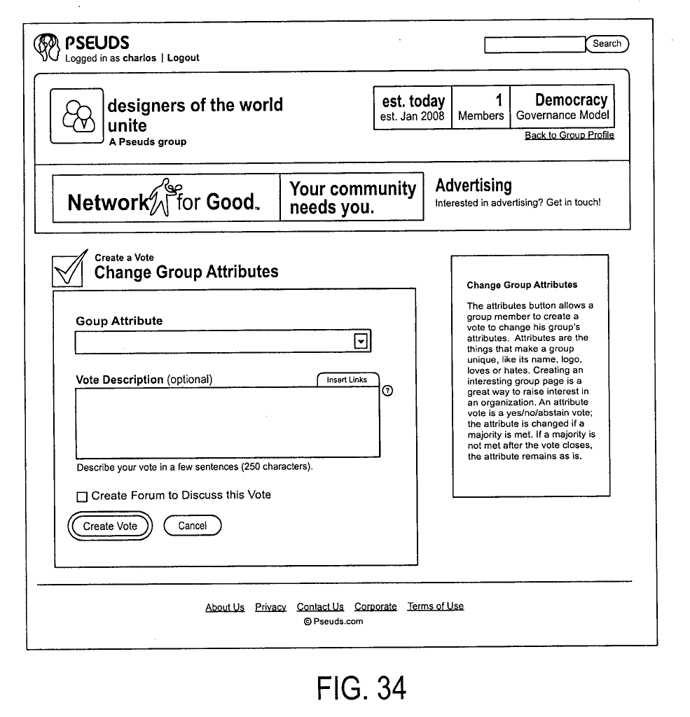

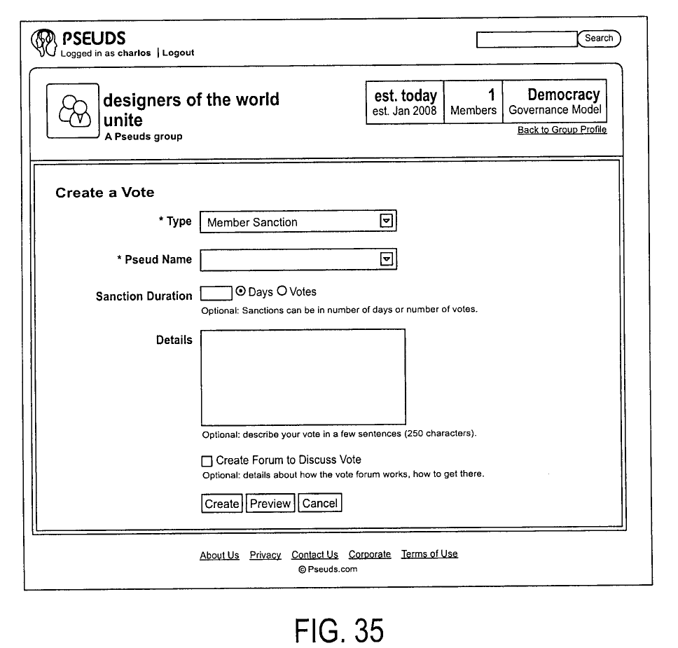

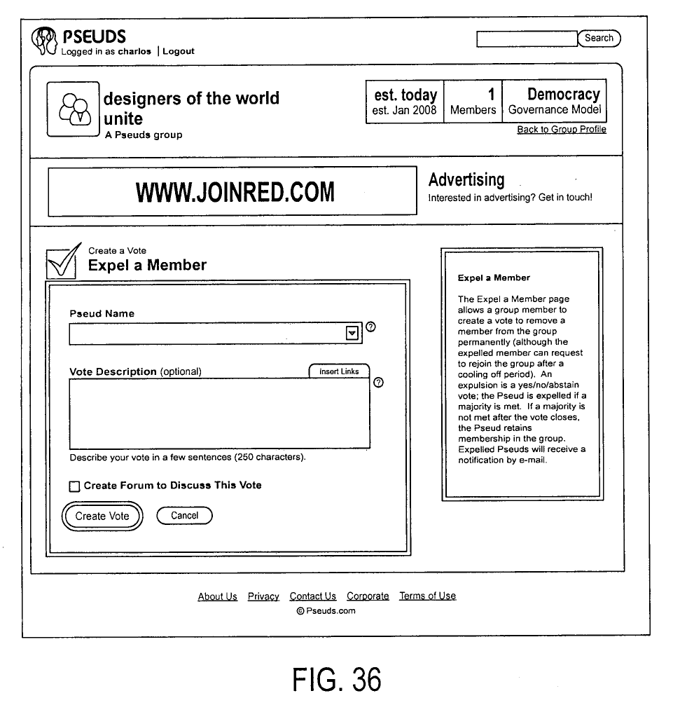

The system enables the member to create votes for different actions, including inviting a new member to the group (FIG. 30). The system enables the member to cast a vote (FIG. 31) and provides summary information on the vote (FIG. 32). Other actions for which a vote can be created include creating a group event (FIG. 33), changing group attributes (FIG. 34), sanctioning a member of the group (FIG. 35) and expelling a member of the group (FIG. 36).

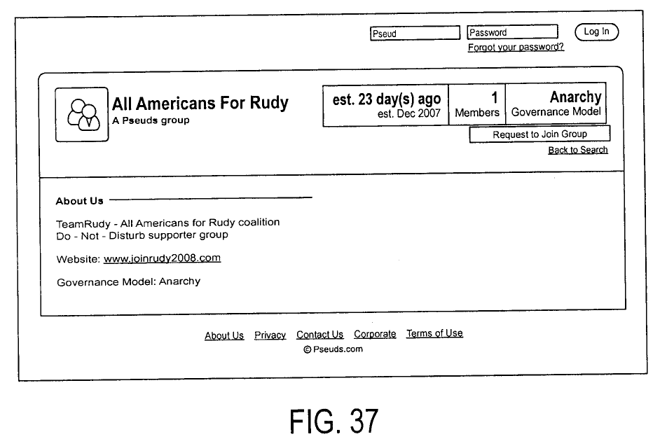

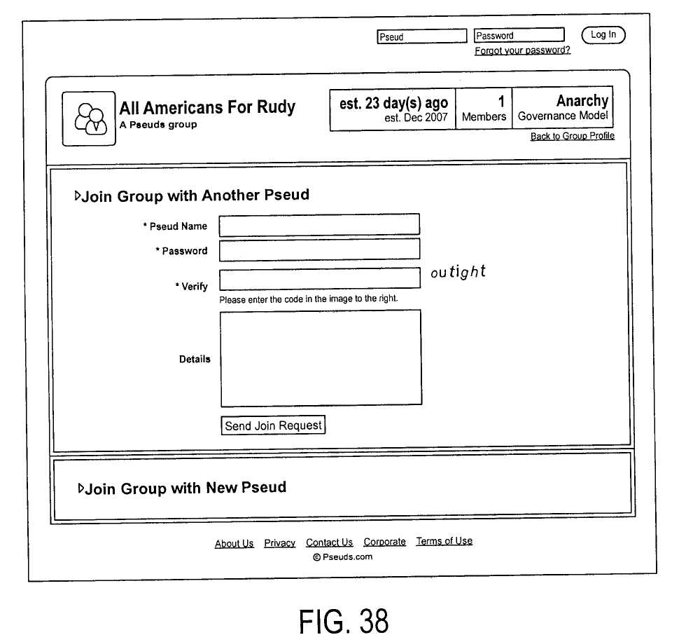

The system also enables users to form different groups under distinct governance models and participate between groups. In the illustrated embodiment, a second group labeled “All Americans For Rudy” is formed (FIG. 37) under an anarchy governance model. The system enables the member to send a join request to another group (FIG. 38) that requests the member's group to be joined with the other group.

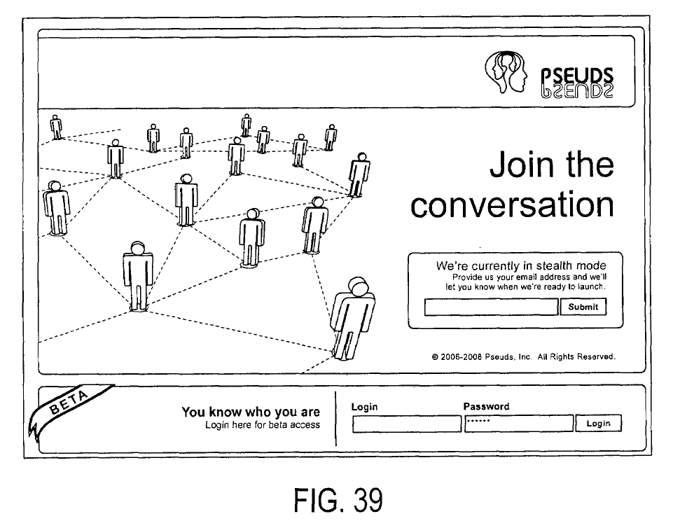

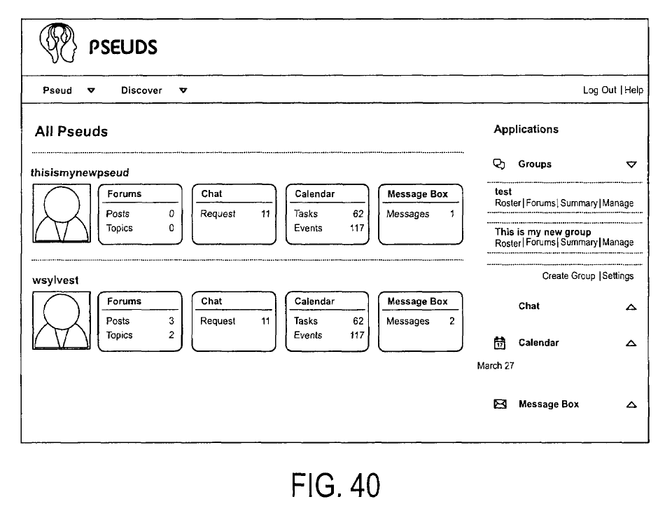

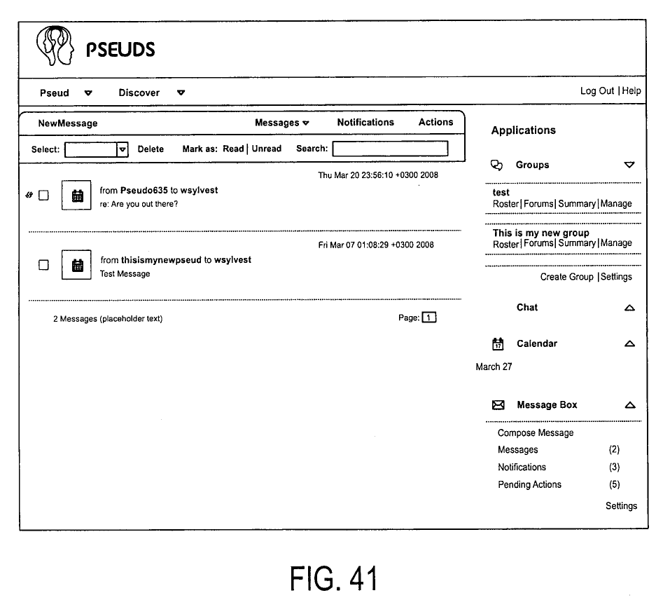

FIGS. 39-45 illustrate examples of another embodiment of a user interface associated with a multi-governance social networking system. In the illustrated embodiment, the system enables a user to log in (FIG. 39) and view (FIG. 40) registered identities associated with the user (“thisismynewpseud” and “wsylvest” in the illustrated embodiment) and available groups associated with the system (“test” and “This is my new group” in the illustrated embodiment). The system provides applications for the user, such as a chat application, calendar application and message box application (FIG. 41) in the illustrated embodiment.

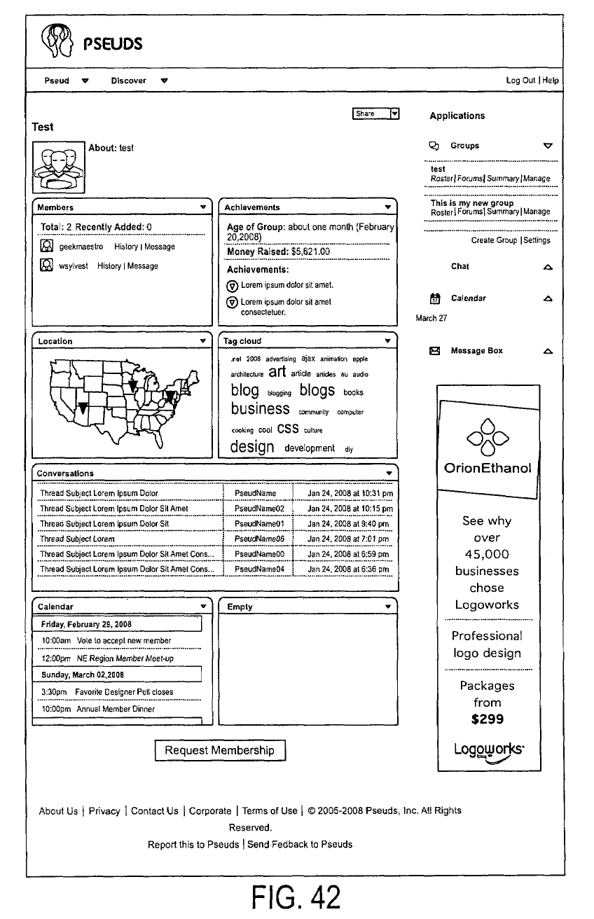

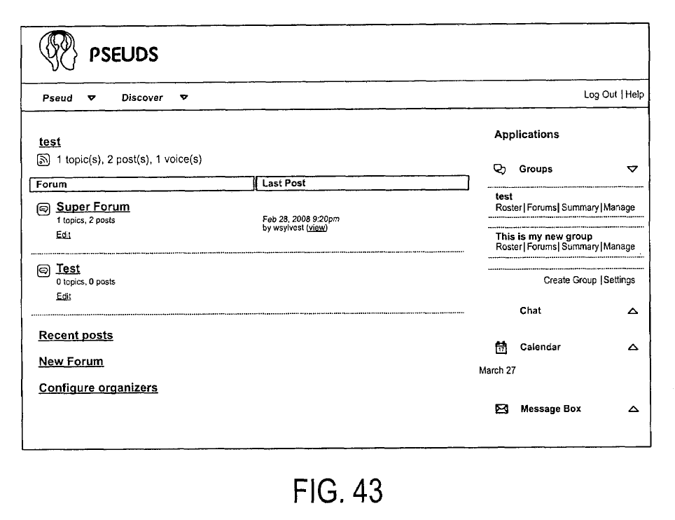

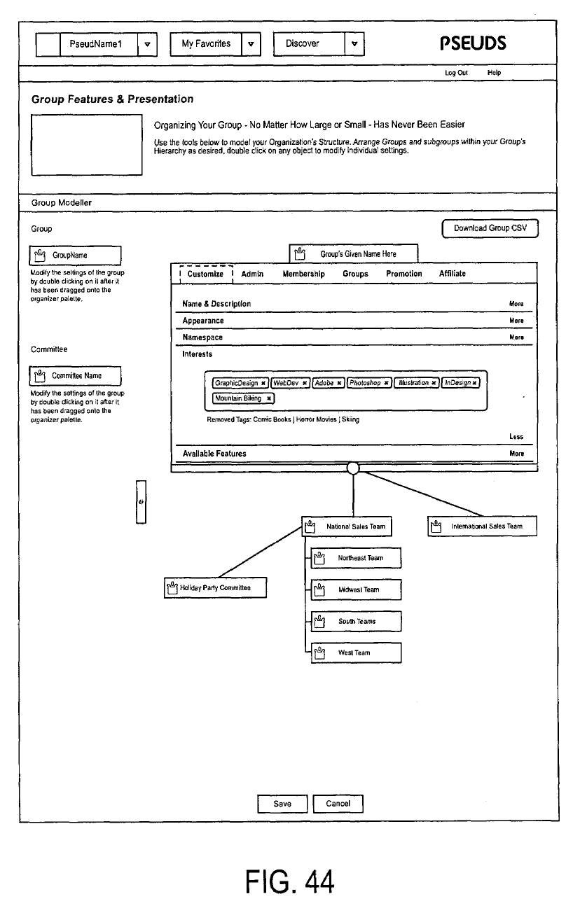

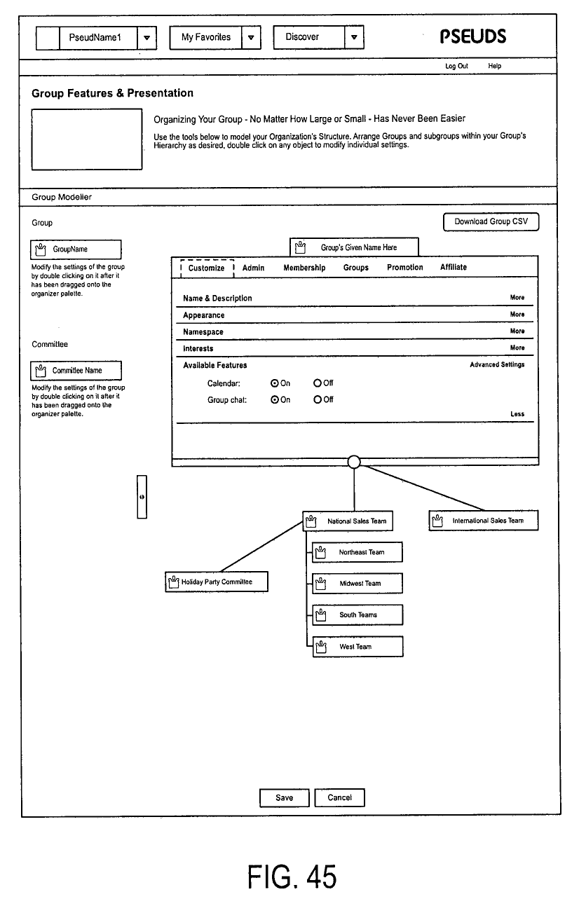

The system enables the user to view summary information associated with a group and to request membership in the group (FIG. 42), and to participate in group applications such as a forum (FIG. 43) in the illustrated embodiment. The system also provides modeling functionality to enable a user to create and manage a group or groups according to a user-customizable structure (FIGS. 44 and 45).

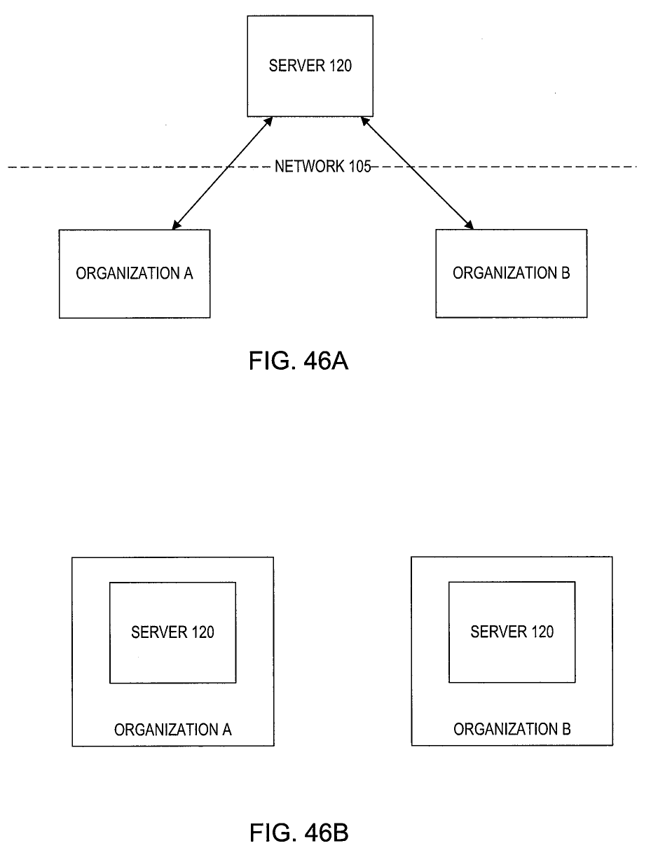

The system of the present disclosure may be implemented in any suitable manner, such as in a single or multi-tenanted fashion for example. As shown in FIG. 46A, a multi-tenanted implementation comprises server 120 installed at a central location across network 105. In the illustrated embodiment, different organizations taking part in social networking groups provided by server 120 can interface with server 120 at its central location. As shown in FIG. 46B, a single-tenanted implementation comprises server 120 installed at each organization's location. In the illustrated embodiment, each organization hosts server 120 and provides the social networking capabilities of the present disclosure in house.

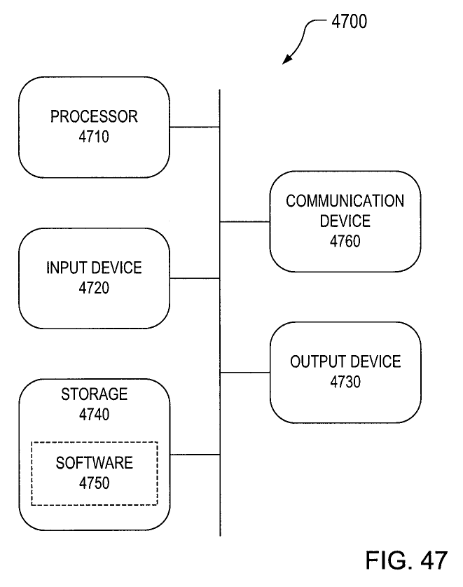

FIG. 47 shows a block diagram of an example of a computing device, which may generally correspond to member client 100, member client 110 and server 120. The form of computing device 4700 may be widely varied. For example, computing device 4700 may be a personal computer, workstation, server, handheld computing device, or any other type of microprocessor-based device. Computing device 4700 may include, for example, one or more of processor 4710, input device 4720, output device 4730, storage 4740, and communication device 4760. These elements may also be widely varied.

For example, input device 4720 may include a keyboard, mouse, pen-operated touch screen or monitor, voice-recognition device, or any other device that provides input. Output device 4730 may include, for example, a monitor, printer, disk drive, speakers, or any other device that provides output.

Storage 4740 may include, for example, volatile and nonvolatile data storage, including one or more electrical, magnetic or optical memories such as a RAM, cache, hard drive, CD-ROM drive, tape drive or removable storage disk. Communication device 4760 may include, for example, network interface card, modem or any other device capable of transmitting and receiving signals over a network. The components of the computing device may be connected, for example, via a physical bus or wirelessly.

Software 4750, which may be stored in storage 4740 and executed by processor 4710, may include, for example, the application programming that embodies the functionality of the present disclosure (e.g., as embodied in server 120). Software 4750 may include, for example, a combination of servers such as application servers and database servers.

Network 105 may include any type of interconnected communication system, which may implement any communications protocol, which may be secured by any security protocol. The corresponding network links may include, for example, telephone lines, DSL, cable networks, T1 or T3 lines, wireless network connections, or any other arrangement that implements the transmission and reception of network signals.

The computing device may implement any operating system, such as Windows or UNIX for example. Software 4750 may be written in any programming language or application framework, such as C, C++, Java, Ruby on Rails, Flash or Flex for example. In various embodiments, application software embodying the functionality of the present disclosure may be deployed on a standalone machine, in a client/server arrangement or through a Web browser as a Web-based application or Web service, for example.

Although the claimed subject matter has been fully described in connection with examples thereof with reference to the accompanying drawings, it is to be noted that various changes and modifications will become apparent to those skilled in the art. Such changes and modifications are to be understood as being included within the scope of the present disclosure as defined by the appended claims.

What is claimed is:

1. A system comprising:
a data store configured to store governance model rules; and
a server configured to apply the stored rules to implement a first online social networking group under a first governance model and a second online social networking group under a second governance model.

2. The system of claim 1, wherein the first governance model determines which members of the first group have authority to make decisions in association with the implementation of the first group.

3. The system of claim 1, wherein the first governance model includes a single leader governance model.

4. The system of claim 1, wherein the first governance model includes a multi-leader governance model.

5. The system of claim 1, wherein the first governance model includes a no leader governance model.

6. The system of claim 1, wherein the server is further configured to:
solicit from a designated leader of the first group one or more preferences attributable to the first group; and
serve ads to the first group based on the solicited preferences.

7. The system of claim 1, wherein the server is further configured to:
aggregate one or more preferences of members of the first group; and
serve ads to the first group based on the aggregated preferences.

8. The system of claim 1, wherein revenue resulting from serving ads to the first group is shared with members of the first group.

9. The system of claim 1, wherein the server is further configured to:
calculate a reputation score for a member of the first group in connection with governance of the first group.

10. The system of claim 1, wherein the server is further configured to:
calculate a reputation score for the first group in connection with governance of the first group.

11. The system of claim 1, wherein the server is further configured to:
implement a relationship between the first group and the second group in which one of the groups has governing authority over the other.

12. The system of claim 1, wherein the server is further configured to:
implement a relationship between the first group and the second group in which neither of the groups has governing authority over the other.

13. The system of claim 1, wherein the server is further configured to:
implement an alliance between the first group and the second group.

14. The system of claim 1, wherein the server is further configured to:
implement a feud between the first group and the second group.

15. A method comprising:
providing a user with configurable options associated with a plurality of governance models in connection with forming an online social networking group;
receiving a configuration by the user specifying one of the plurality of governance models; and
implementing the online social networking group based on the specified governance model.

16. The method of claim 15, wherein the specified governance model determines which members of the group have authority to make decisions in association with the implementation of the group.

17. The method of claim 15, wherein the plurality of governance models include a single leader governance model.

18. The method of claim 15, wherein the plurality of governance models include a multi-leader governance model.

19. The method of claim 15, wherein the plurality of governance models include a no leader governance model.

20. The method of claim 15, further comprising:
soliciting from a designated leader of the group one or more preferences attributable to the group; and
serving ads to the group based on the solicited preferences.

21. The method of claim 15, further comprising:
aggregating one or more preferences of members of the group; and
serving ads to the group based on the aggregated preferences.

22. The method of claim 15, wherein revenue resulting from serving ads to the group is shared with members of the group.

23. The method of claim 15, further comprising:
calculating a reputation score for a member of the group based on an action by the member associated with governance of the group.

24. The method of claim 15, further comprising:
calculating a reputation score for the group based on actions by the group associated with governance of the group.

25. The method of claim 15, further comprising:
implementing a relationship between the online social networking group and another online social networking group in which one of the groups has governing authority over the other.

26. The method of claim 15, further comprising:
implementing a relationship between the online social networking group and another online social networking group in which neither of the groups has governing authority over the other.

27. The method of claim 15, further comprising:
implementing an alliance between the online social networking group and another online social networking group.

28. The method of claim 15, further comprising:
implementing a feud between the online social networking group and another online social networking group.
